(19) United States
(12) Patent Application Publication
(10) Pub. No.: US 2025/0372335 A1
(43) Pub. Date: Dec. 4, 2025

(54) ELECTROSTATIC LINEAR ION TRAP

(71) Applicant: THE TRUSTEES OF INDIANA UNIVERSITY, Bloomington, IN (US)

(72) Inventors: Martin F. Jarrold, Bloomington, IN (US); David W. Reitenbach, Bloomington, IN (US); Raj Alpesh Parikh, Bloomington, IN (US)

(21) Appl. No.: 19/216,008

(22) Filed: May 22, 2025

Related U.S. Application Data
(60) Provisional application No. 63/652,232, filed on May 28, 2024.

(51) Int. Cl. H01J 3/16; H01J 49/42

(52) U.S. Cl. CPC H01J 3/16; H01J 49/4245

(57) ABSTRACT

An electrostatic linear ion trap has first and second axially aligned ion mirrors separated by a charge detection cylinder and first and second nozzles, all axially aligned with each other. Electric fields are selectively established within the first and second ion mirrors in a manner which causes an ion in the trap to oscillate back and forth through the charge detection cylinder between the first and second ion mirrors. The first and second nozzles are configured to reduce noise in a charge detection signal related to charges induced on the charge detection cylinder due to oscillation of the ion back and forth through the charge detection cylinder between the first and second ion mirrors.

### CROSS-REFERENCE TO RELATED APPLICATION

This patent application claims the benefit of, and priority to, U.S. Provisional Patent Application Ser. No. 63/652,232, filed 28 May 2024, the entire disclosure of which is hereby incorporated herein by reference.

### GOVERNMENT RIGHTS

This invention was made with government support under GM131100 awarded by National Institutes of Health. The United States Government has certain rights in the invention.

### FIELD OF THE DISCLOSURE

The present disclosure relates generally to charge detection mass spectrometry instruments, and more specifically to performing mass and charge measurements with such instruments.

### BACKGROUND

Mass spectrometry provides for the identification of chemical components of a substance by separating gaseous ions of the substance according to ion mass and charge. Various instruments and techniques have been developed for determining the masses of such separated ions, and one such technique is known as charge detection mass spectrometry (CDMS). In CDMS, ion mass is determined as a function of measured ion mass-to-charge ratio, typically referred to as “m/z,” and measured ion charge.

High levels of uncertainty in m/z and charge measurements with early CDMS detectors has led to the development of an electrostatic linear ion trap (ELIT) detector in which ions are made to oscillate back and forth through a charge detection cylinder. Multiple passes of ions through such a charge detection cylinder provides for multiple measurements for each ion, and it has been shown that the uncertainty in charge measurements decreases with n^{1/2}, where n is the number of measurements. However, in the continued quest for greater measurement resolution, the ELIT remains limited by uncertainties in both m/z measurements and charge measurements. Accordingly, it is desirable to seek improvements in ELIT design and/or operation which further reduce measurement uncertainties for either or both of ion charge and mass-to-charge ratio (m/z).

### SUMMARY

The present disclosure may comprise one or more of the features recited in the attached claims and/or one or more of the following features and combinations thereof.

In a first aspect, an electrostatic linear ion trap may comprise a first ion mirror defining a first axial passageway therethrough; a first ground electrode defining a second axial passageway therethrough and positioned adjacent the first ion mirror; a second ion mirror defining a third axial passageway therethrough; a second ground electrode defining a fourth axial passageway therethrough and positioned adjacent the second ion mirror; a charge detection cylinder defining a fifth axial passageway therethrough and positioned between the first and second ground electrodes; a first nozzle defining a sixth axial passageway therethrough and extending outwardly from the first ground electrode toward the charge detection cylinder to position the first nozzle adjacent the charge detection cylinder; a second nozzle defining a seventh axial passageway therethrough and extending outwardly from the second ground electrode toward the charge detection cylinder to position the second nozzle adjacent the charge detection cylinder; and at least one voltage source coupled to the first and second ion mirrors, the at least one voltage source configured to establish electric fields in each of the first and second ion mirrors configured to reflect an ion entering a respective one of the first and third axial passageways from the fifth axial passageway of the charge detection cylinder back through the fifth axial passageway of the charge detection cylinder and toward the other of the first and third axial passageways such that the ion oscillates back and forth through the charge detection cylinder between the first and second ion mirrors, wherein the first nozzle and the second nozzle may be configured to reduce noise in a charge detection signal related to charges induced on the charge detection cylinder due to oscillation of the ion back and forth through the charge detection cylinder between the first and second ion mirrors.

A second aspect includes the features of the first aspect, and wherein the first, second, third, fourth, fifth, sixth, and seventh axial passageways may be in-line with each other relative to an axis.

A third aspect includes the features of the first aspect, and wherein each of the first and second ion mirrors may comprise a plurality of axially spaced apart mirror electrodes defining the first and third axial passageways respectively therethrough, and wherein the at least one voltage source may comprise a plurality of voltage sources each electrically connected to a different one of the plurality of spaced apart mirror electrodes of the first and second ion mirrors, each of the plurality of voltage sources may be configured to apply a potential to a corresponding one of the plurality of mirror electrodes to establish the electric fields between at least some of the spaced apart mirror electrodes of each of the first and second ion mirrors.

A fourth aspect includes the features of the first aspect, and the electrostatic linear ion trap may further comprise a processor and a memory having instructions stored therein which, when executed by the processor, cause the processor to control the at least one voltage source to produce at least one output voltage to establish the electric fields in the first and third axial passageways of the first and second ion mirrors, respectively.

A fifth aspect includes the features of the first aspect, and wherein a first axial length may be defined between a proximal end of the first axial passageway defined by the first ion mirror and one end of the charge detection cylinder adjacent to a distal end of the first nozzle, a second axial length may be defined between a proximal end of the third axial passageway defined by the second ion mirror and an opposite end of the charge detection cylinder adjacent to a distal end of the second nozzle, and a third axial length may be defined along the fifth axial passageway between the one end of the charge detection cylinder and the opposite end of the charge detection cylinder, and wherein the at least one voltage source may be configured to establish the electric fields in each of the first and second ion mirrors by applying at least one output voltage to each of the first and second ion mirrors, the at least one output voltage may have at least one magnitude based, at least in part, on the first, second, and third axial lengths.

A sixth aspect includes the features of the fifth aspect, and wherein the first axial length may be approximately equal to the second axial length, and wherein the third axial length may be greater than each of the first and second axial lengths.

A seventh aspect includes the features of the fifth aspect or the sixth aspect, and wherein the first axial passageway of the first ion mirror may define a first cross-sectional area normal to the first axial length, the third axial passageway of the second ion mirror may define a second cross-sectional area normal to the second axial length, and the fifth axial passageway may define a third cross-sectional area normal to the third axial length, and wherein the at least one magnitude may be further based, at least in part, on the first, second, and third cross-sectional areas.

An eighth aspect includes the features of the seventh aspect, and wherein the first cross-sectional area may be approximately equal to the second cross-sectional area, and wherein the third cross-sectional area may be less than each of the first and second cross-sectional areas.

A ninth aspect includes the features of the seventh aspect or the eighth aspect, and wherein the sixth axial passageway of the first nozzle may define a fourth cross-sectional area normal to the first axial length and the seventh axial passageway may define a fifth cross-sectional area normal to the second axial length, wherein the fourth cross-sectional area may be approximately equal to the fifth cross-sectional area, and wherein the fourth and fifth cross-sectional areas may be each less than the third cross-sectional area.

A tenth aspect includes the features of any of the first through the ninth aspects, and the electrostatic linear ion trap may further comprise a processor operatively coupled to the charge detection cylinder, the charge detection cylinder producing the charge detection signal for each corresponding detection of the ion passing through the fifth axial passageway, and a memory having instructions stored therein which, when executed by the processor, cause the processor to store the charge detection signals produced by the charge detection cylinder in the memory.

An eleventh aspect includes the features of the tenth aspect, and wherein the memory may further include instructions stored therein which, when executed by the processor, cause the processor to compute a Fourier transform of a plurality of the stored charge detection signals resulting from oscillation of the ion multiple times back and forth through the fifth axial passageway of the charge detection cylinder between the first and second ion mirrors, to compute a mass-to-charge ratio of the ion as a function of a fundamental frequency of the Fourier transform, to compute a charge of the ion as a function of a magnitude of the fundamental frequency of the Fourier transform taking into account the number oscillations of the ion, and to compute a mass of the ion based on the computed mass-to-charge ratio and the computed charge.

A twelfth aspect includes the features of the tenth aspect or the eleventh aspect, and the electrostatic linear ion trap may further comprise a charge pre-amplifier operatively coupled between the charge detection cylinder and the processor, the charge pre-amplifier amplifying the charge detection signals, the processor digitizing the amplified charge detection signals and storing the digitized, amplified charge detection signals in the memory.

A thirteenth aspect includes the features of any of the first aspect through the twelfth aspect, and wherein a distance may be formed between the first ground electrode and the charge detection cylinder, the first nozzle may have a length that is less than the distance between the first ground electrode and the charge detection cylinder to form a gap between the first nozzle and the charge detection cylinder, and wherein the distance may be formed between the second ground electrode and the charge detection cylinder, the second nozzle may have the length that is less than the distance between the second ground electrode and the charge detection cylinder to form the gap between the second nozzle and the charge detection cylinder.

In a fourteenth aspect, an electrostatic linear ion trap may comprise a first ion mirror defining a first axial passageway therethrough; a second ion mirror identical to the first ion mirror and defining a second axial passageway therethrough identical to the first axial passageway defined through the first ion mirror; a charge detection cylinder defining a third axial passageway therethrough, the charge detection cylinder positioned between the first and second ion mirrors; a first nozzle defining a fourth axial passageway therethrough and positioned between the first ion mirror and the charge detection cylinder; a second nozzle identical to the first nozzle and defining a fifth axial passageway therethrough identical to the fourth axial passageway defined through the first nozzle, the second nozzle positioned between the charge detection cylinder and the second ion mirror such that the first, second, third, fourth, and fifth axial passageways are in-line with each other; and at least one voltage source coupled to the first and second ion mirrors, the at least one voltage source configured to establish electric fields in each of the first and second ion mirrors configured to reflect an ion entering a respective one of the first and second axial passageways from the third axial passageway of the charge detection cylinder back through the third axial passageway of the charge detection cylinder and into the other of the first and second axial passageways such the ion oscillates back and forth through the charge detection cylinder between the first and second ion mirrors.

A fifteenth aspect includes the features of the fourteenth aspect, and wherein the first nozzle may be spaced apart from the charge detection cylinder to form a gap therebetween, and wherein the second nozzle may be spaced apart from the charge detection cylinder to form the gap therebetween.

A sixteenth aspect includes the features of the fourteenth aspect, and wherein the first and second ion mirrors may each comprise a plurality of axially spaced apart mirror electrodes defining the first and second axial passageways respectively therethrough, and wherein the at least one voltage source may comprise a plurality of voltage sources each electrically connected to a different one of the plurality of spaced apart mirror electrodes of the first and second ion mirrors, the plurality of voltage sources may be configured to apply a potential to a corresponding one of the plurality of mirror electrodes to establish the electric fields between at least some of the spaced apart mirror electrodes of each of the first and second ion mirrors.

A seventeenth aspect includes the features of the fourteenth aspect, and the electrostatic linear ion trap may further comprise a processor and a memory having instructions stored therein which, when executed by the processor, cause the processor to control the at least one voltage source to produce at least one output voltage to establish the electric fields in the first and second axial passageways of the first and second ion mirrors respectively.

An eighteenth aspect includes the features of the fourteenth aspect, and wherein a first axial length may be defined between a proximal end of the first axial passageway defined by the first ion mirror and a first end of the charge detection cylinder adjacent to the first nozzle, a second axial length may be defined between a proximal end of the second axial passageway defined by the second ion mirror and second end of the charge detection cylinder opposite the first end thereof and adjacent to the second nozzle, and a third axial length may be defined along the third axial passageway between the first and second ends of the charged detection cylinder, and wherein the at least one voltage source may be configured to establish electric fields in each of the first and second ion mirrors by applying at least one output voltage to each of the first and second ion mirrors, the at least one output voltage having at least one magnitude based, at least in part, on the first, second and third axial lengths.

A nineteenth aspect includes the features of the eighteenth aspect, and wherein the first axial length may be approximately equal to the second axial length, and wherein the third axial length may be greater than each of the first and second axial lengths.

A twentieth aspect includes the features of the eighteenth aspect or the nineteenth aspect, and wherein the first axial passageway may define a first cross-sectional area normal to the first axial length, the second axial passageway may define a second cross-sectional area normal to the second axial length, and the third axial passageway may define a third cross-sectional area normal to the third axial length, and wherein the at least one magnitude may be further based, at least in part, on the first, second, and third cross-sectional areas.

A twenty-first aspect includes the features of the twentieth aspect, and wherein the first cross-sectional area may be approximately equal to the second cross-sectional area, and wherein the third cross-sectional area may be less than each of the first and second cross-sectional areas.

A twenty-second aspect includes the features of the twentieth aspect or the twenty-first, and wherein the fourth axial passageway of the first nozzle may define a fourth cross-sectional area normal to the first axial length and the fifth axial passageway of the second nozzle may define a fifth cross-sectional area normal to the second axial length, wherein the fourth cross-sectional area may be approximately equal to the fifth cross-sectional area, and wherein the fourth and fifth cross-sectional areas may each be less than the third cross-sectional area.

A twenty-third aspect includes the features of any of the fourteenth aspect through the twenty-second aspect, and the electrostatic linear ion trap may further comprise a processor operatively coupled to the charge detection cylinder, the charge detection cylinder producing a charge detection signal for each corresponding detection of the ion passing through the third passageway, and a memory having instructions stored therein which, when executed by the processor, cause the processor to store the charge detection signals produced by the charge detection cylinder in the memory.

A twenty-fourth aspect includes the features of the twenty-third aspect, and wherein the memory may further include instructions stored therein which, when executed by the processor, cause the processor to compute a Fourier transform of a plurality of the stored charge detection signals resulting from oscillation of the ion multiple times back and forth through the charge detection cylinder between the first and second ion mirrors, to compute a mass-to-charge ratio of the ion as a function of a fundamental frequency of the Fourier transform, to compute a charge of the ion as a function of a magnitude of the fundamental frequency of the Fourier transform taking into account the number oscillations of the ion, and to compute a mass of the ion based on the computed mass-to-charge ratio and the computed charge.

A twenty-fifth aspect includes the features of the twenty-third aspect or the twenty-fourth aspect, and the electrostatic linear ion trap may further comprise a charge pre-amplifier operatively coupled between the charge detection cylinder and the processor, the charge pre-amplifier amplifying the charge detection signals, the processor digitizing the amplified charge detection signal and storing the digitized, amplified charge detection signals in the memory.

In a twenty-sixth aspect, a system for separating ions may comprise an ion source configured to generate ions from a sample; at least one ion separation instrument configured to separate the generated ions as a function of at least one molecular characteristic; and the electrostatic linear ion trap of any of first through the twenty-fifth aspects, wherein one of the first and second ion mirrors may define an aperture configured to allow passage of at least one ion exiting the at least one ion separation instrument into the one of the first and second ion mirrors for oscillation thereof back and forth through the charge detection cylinder between the first and second ion mirrors.

A twenty-seventh aspect includes the features of the twenty-sixth aspect, and wherein the at least one ion separation instrument may comprise one or any combination of at least one instrument for separating ions as a function of mass-to-charge ratio, at least one instrument for separating ions in time as a function of ion mobility, at least one instrument for separating ions as a function of ion retention time and at least one instrument for separating ions as a function of molecule size.

A twenty-eighth aspect includes the features of the twenty-sixth aspect, and wherein the at least one ion separation instrument may comprise one or a combination of a mass spectrometer and an ion mobility spectrometer.

A twenty-ninth aspect includes the features of any of the twenty-sixth aspect through the twenty-eighth aspect, and the system may further comprise at least one ion processing instrument positioned between the ion source and the at least one ion separation instrument, the at least one ion processing instrument positioned between the ion source and the at least one ion separation instrument may comprise one or any combination of at least one instrument for collecting or storing ions, at least one instrument for filtering ions according to a molecular characteristic, at least one instrument for dissociating ions and at least one instrument for normalizing or shifting ion charge states.

A thirtieth aspect includes the features of any of the twenty-sixth aspect through the twenty-ninth aspect, and the system may further comprise at least one ion processing instrument positioned between the at least one ion separation instrument and the electrostatic linear ion trap, the at least one ion processing instrument positioned between the at least one ion separation instrument and the electrostatic linear ion trap may comprise one or any combination of at least one instrument for collecting or storing ions, at least one instrument for filtering ions according to a molecular characteristic, at least one instrument for dissociating ions and at least one instrument for normalizing or shifting ion charge states.

A thirty-first aspect includes the features of any of the twenty-sixth aspect through the thirtieth aspect, and wherein the other of the first and second ion mirrors may define an aperture configured to allow ion exit from the electrostatic linear ion trap, and wherein the system may further comprise at least one ion separation instrument positioned to receive ions exiting the electrostatic linear ion trap and to separate the received ions as a function of at least one molecular characteristic.

A thirty-second aspect includes the features of the thirty-first aspect, and the system may further comprise at least one ion processing instrument positioned between the electrostatic linear ion trap and the at least one ion separation instrument, the at least one ion processing instrument positioned between the electrostatic linear ion trap and the at least one ion separation instrument may comprise one or any combination of at least one instrument for collecting or storing ions, at least one instrument for filtering ions according to a molecular characteristic, at least one instrument for dissociating ions and at least one instrument for normalizing or shifting ion charge states.

A thirty-third aspect includes the features of the thirty-first aspect, and the system may further comprise at least one ion processing instrument positioned to receive ions exiting the at least one ion separation instrument that is itself positioned to receive ions exiting the electrostatic linear ion trap, the at least one ion processing instrument positioned to receive ions exiting the at least one ion separation instrument that is positioned to receive ions exiting the electrostatic linear ion trap may comprise one or any combination of at least one instrument for collecting or storing ions, at least one instrument for filtering ions according to a molecular characteristic, at least one instrument for dissociating ions and at least one instrument for normalizing or shifting ion charge states.

A thirty-fourth aspect includes the features of any of the twenty-sixth aspect through the thirtieth, and wherein the other of the first and second ion mirrors may define an aperture configured to allow ion exit from the electrostatic linear ion trap, and wherein the system may further comprise at least one ion processing instrument positioned to receive ions exiting the electrostatic linear ion trap, the at least one ion processing instrument positioned to receive ions exiting the electrostatic linear ion trap may comprise one or any combination of at least one instrument for collecting or storing ions, at least one instrument for filtering ions according to a molecular characteristic, at least one instrument for dissociating ions and at least one instrument for normalizing or shifting ion charge states.

In a thirty-fifth aspect, a system for separating ions may comprise an ion source configured to generate ions from a sample; a first mass spectrometer configured to separate the generated ions as a function of mass-to-charge ratio; an ion dissociation stage positioned to receive ions exiting the first mass spectrometer and configured to dissociate ions exiting the first mass spectrometer; a second mass spectrometer configured to separate dissociated ions exiting the ion dissociation stage as a function of mass-to-charge ratio, and a charge detection mass spectrometer (CDMS), including the electrostatic linear ion trap of any of the first aspect through the twenty-fifth aspect, coupled in parallel with and to the ion dissociation stage such that the CDMS can receive ions exiting either of the first mass spectrometer and the ion dissociation stage, wherein masses of precursor ions exiting the first mass spectrometer may be measured using CDMS, mass-to-charge ratios of dissociated ions of precursor ions having mass values below a threshold mass may be measured using the second mass spectrometer, and mass-to-charge ratios and charge values of dissociated ions of precursor ions having mass values at or above the threshold mass may be measured using the CDMS.

In a thirty-sixth aspect, a method of operating an electrostatic linear ion trap having first and second ion mirrors separated by a charge detection cylinder and first and second nozzles separated by the charge detection cylinder, each of the first and second ion mirrors, the charge detection cylinder, and the first and second nozzles axially aligned with one another, the method may comprise establishing a first electric field in the first ion mirror, the first electric field configured and oriented to stop in the first ion mirror an ion exiting a first end of the charge detection cylinder proximate to the first nozzle and traveling into the first ion mirror, and to accelerate the stopped ion in the first ion mirror back through the first nozzle and into the first end of the charge detection cylinder; and establishing a second electric field in the second ion mirror, the second electric field configured and oriented to stop in the second ion mirror the ion exiting a second end of the charge detection cylinder, opposite the first end thereof, proximate to the second nozzle and traveling into the second ion mirror, and to accelerate the stopped ion in the second ion mirror back through the second nozzle and the second end of the charge detection cylinder, such that the ion oscillates through the charge detection cylinder back and forth between the first and second ion mirrors under the influence of the first and second electric fields.

A thirty-seventh aspect includes the features of the thirty-sixth aspect, and wherein the first and second ion mirrors may each comprise a plurality of axially spaced apart mirror electrodes defining a first passageway and a second passageway respectively therethrough, and wherein establishing the first electric field may comprise applying selected potentials across at least two of the plurality of spaced apart mirror electrodes of the first ion mirror, and wherein establishing the second electric field may comprise applying selected potentials across at least two of the plurality of spaced apart mirror electrodes of the second ion mirror.

A thirty-eighth aspect includes the features of the thirty-sixth aspect, and wherein the charge detection cylinder may produce a charge detection signal each time the ion passes therethrough, and wherein the method may further comprise storing the charge detection signals produced by the charge detection cylinder in a memory.

A thirty-ninth aspect includes the features of the thirty-eighth aspect, and the method may further comprise reducing noise in the charge detection signals via the first and second nozzles.

A fortieth aspect includes the features of the thirty-eighth aspect, and the method may further comprise computing a Fourier transform of a plurality of the stored charge detection signals resulting from oscillation of the ion multiple times back and forth through the charge detection cylinder between the first and second ion mirrors, and computing a mass-to-charge ratio of the ion as a function of a fundamental frequency of the Fourier transform.

A forty-first aspect includes the features of the fortieth aspect, and the method may further comprise computing a charge of the ion as a function of a magnitude of the fundamental frequency of the Fourier transform taking into account the number oscillations of the ion, and computing a mass of the ion based on the computed mass-to-charge ratio and the computed charge.

A forty-second aspect includes the features of any of the thirty-eighth aspect through the forty-first aspect, and wherein storing the charge detection signals produced by the charge detection cylinder may comprise amplifying the charge detection signals, digitizing the amplified charge detection signals, and storing the digitized, amplified charge detection signals in the memory.

A forty-third aspect includes the features of any of the thirty-sixth aspect through the forty-second aspect, and wherein a first axial length may be defined between a proximal end of the first ion mirror and one end of the charge detection cylinder adjacent to the first nozzle, a second axial length may be defined between a proximal end of the second ion mirror and an opposite end of the charge detection cylinder adjacent to the second nozzle, and a third axial length may be defined between the one end of the charge detection cylinder and the opposite end of the charge detection cylinder, and wherein establishing the first electric field may comprise applying at least a first voltage to the first ion mirror, the at least the first voltage may have at least one magnitude based, at least in part, on the first, second, and third axial lengths, and wherein establishing the second electric field may comprise applying at least a second voltage to the second ion mirror, the at least the second voltage may have at least one magnitude based, at least in part, on the first, second and third axial lengths.

A forty-fourth aspect includes the features of the forty-third aspect, and the method may further comprise sizing the first axial length to be approximately equal to the second axial length, and sizing the third axial length to be greater than each of the first and second axial lengths.

A forty-fifth aspect includes the features of the forty-third aspect or the forty-fourth aspect, and wherein the first ion mirror may define a first axial passageway defining a portion of the first axial length, the first axial passageway may have a first cross-sectional area normal to the first axial length, and wherein the second ion mirror may define a second axial passageway defining a portion of the second axial length, the second axial passageway may have a second cross-sectional area normal to the second axial length, and wherein the charge detection cylinder may define a third axial passageway therethrough defining the third axial length, the third axial passageway may have a third cross-sectional area normal to the third axial length, and wherein the at least one magnitude of each of the first voltage and the second voltage may be further based, at least in part, on the first, second, and third cross-sectional areas.

A forty-sixth aspect includes the features of any of the forty-third aspect through the forty-fifth aspect, and wherein the first nozzle may define a fourth axial passageway defining another portion of the first axial length, the fourth axial passageway may have a fourth cross-sectional area normal to the first axial length, and wherein the second nozzle may define a fifth axial passageway defining another portion of the second axial length, the fifth axial passageway may have a fifth cross-sectional area normal to the second axial length.

A forty-seventh aspect includes the features of the forty-sixth aspect, and the method may further comprise sizing the fourth cross-sectional area to be approximately equal to the fifth cross-sectional area, and sizing the fourth cross-sectional area and the fifth cross-sectional area to be less than each of the first, second, and third cross-sectional areas.

A forty-eighth aspect includes the features of any of the forty-fifth aspect through the forty-seventh aspect, and the method may further comprise sizing the first cross-sectional area to be approximately equal to the second cross-sectional area, and sizing the third cross-sectional area to be less than each of the first and second cross-sectional areas.

### BRIEF DESCRIPTION OF THE DRAWINGS

FIG. 1 is a simplified block diagram of an embodiment of an electrostatic linear ion trap (ELIT) illustrating dimensional information;

FIG. 2 is a simplified block diagram of the ELIT of FIG. 1 shown with an ion source and control and measurement components coupled thereto to form an embodiment of a charge detection mass spectrometer (CDMS);

FIG. 3 is a simplified block diagram of an embodiment of an electrostatic linear ion trap (ELIT) illustrating dimensional information;

FIG. 4 is a simplified block diagram of the ELIT of FIG. 3 shown with an ion source and control and measurement components coupled thereto to form an embodiment of a charge detection mass spectrometer (CDMS);

FIG. 5 is a simplified flowchart illustrating an embodiment of a process for controlling operation of the ELIT of FIGS. 1-4 to determine ion mass and charge information;

FIG. 6A is a plot of a normalized time-domain detection signal resulting from the ELIT of FIGS. 1-4 operating with approximately a 50% duty cycle;

FIG. 6B is a plot of relative FFT magnitude vs. oscillation frequency illustrating an FFT of the detection signal of FIG. 6A;

FIG. 7A is a simplified block diagram of an embodiment of an ion separation instrument including the ELIT illustrated in FIGS. 1-4 and operating as described herein, showing example ion processing instruments which may form part of the ion source upstream of the ELIT and/or which may be disposed downstream of the ELIT to further process ion(s) exiting the ELIT;

FIG. 7B is a simplified block diagram of another embodiment of an ion separation instrument including the ELIT illustrated in FIGS. 1-4 and operating as described herein, showing an example implementation which combines conventional ion processing instruments with the CDMS or ELIT illustrated and described herein;

FIG. 8 is a graph of a single ion trajectory through the ELIT of FIG. 1 compared to a single ion trajectory through a different ELIT; and

FIG. 9 is a plot of charge root mean square deviation (RMSD) as a function of input capacitance.

### DESCRIPTION OF THE ILLUSTRATIVE EMBODIMENTS

For the purposes of promoting an understanding of the principles of the disclosure, reference will now be made to a number of illustrative embodiments shown in the attached drawings and specific language will be used to describe the same.

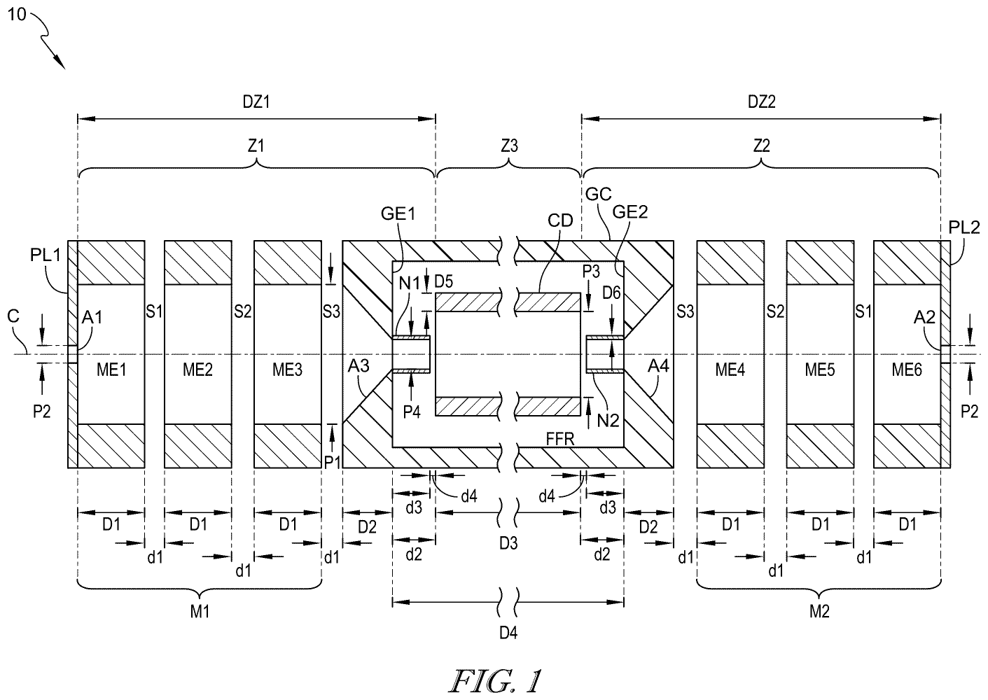

Referring to FIG. 1, a simplified block diagram is shown of an embodiment of an electrostatic linear ion trap (ELIT) 10. In the illustrated embodiment, the ELIT 10 includes a pair of ion mirrors M1, M2 with a charge detector CD positioned therebetween. As will be described in greater detail below, ions introduced into the ELIT 10 are made to oscillate between the ion mirrors M1, M2, each time passing through the charge detector CD. A plurality of charge and oscillation period values are measured at the charge detector CD, and the recorded results are processed to determine ion mass-to-charge ratio and ion mass values.

In the illustrated embodiment, the ion mirror M1 includes three spaced-apart, electrically conductive mirror electrodes ME1-ME3 with a plate or cover PL1 over the exposed face of the electrode ME1. The plate or cover PL1 defines an aperture A1 centrally therethrough which serves as an ion entrance to the ELIT 10. The spaces S1, S2 between the electrodes ME1, ME2 and ME2, ME3, respectively, may be voids in some embodiments, and in other embodiments the spaces S1, S2 may be filled with one or more electrically non-conductive materials, e.g., dielectric materials. The mirror electrodes ME1-ME3 are each illustratively of thickness D1 and define a cylindrical passageway therethrough of diameter P1. The mirror electrodes ME1-ME3 are axially aligned such that a longitudinal axis C passes centrally through each aligned cylindrical passageway and also centrally through the aperture A1. In embodiments in which the spaces S1, S2 include one or more electrically non-conductive materials, such materials will likewise define respective passageways therethrough which are axially aligned with the cylindrical passageways defined through the mirror electrodes ME1-ME3 and which have diameters of P1 or greater. In any case, the spaces S1, S2 each illustratively define a length d1 between opposing faces of the respective mirror electrodes ME1-ME3 such that the axial length, AL1, of the ion mirror M1 is AL1=3D1+2d1. The ion entrance A1 defined through the plate or cover PL1 illustratively has a diameter P2.

Another ion mirror M2 includes mirror electrodes ME4, ME5 and ME6 substantially identical in arrangement, construction, and dimensions to the mirror electrodes ME1, ME2, and ME3, respectively, of the ion mirror M1 as described above, and is spaced apart from the ion mirror M1 such that the distal face of the mirror electrode ME3 faces the distal face of the mirror electrode ME4. A plate or cover PL2 is disposed over the exposed face of the electrode ME6 of the ion mirror M2, and the plate or cover PL2 defines an aperture A2 centrally therethrough, also illustratively of diameter P2, which serves as an ion exit from the ELIT 10. The longitudinal axis C extends centrally through the passageways defined by the mirror electrodes ME4-ME6 and spaces S1, S2 of the mirror electrode M2 as illustrated in FIG. 1.

A charge detector CD in the form of an electrically conductive cylinder of length D3 is positioned between the spaced apart ion mirrors M1, M2. The charge detection cylinder CD illustratively defines a cylindrical passageway axially therethrough of diameter P3, and the charge detection cylinder CD is oriented relative to the ion mirrors M1, M2 such that the longitudinal axis C extending centrally through the passageways defined through the ion mirrors M1, M2 also extends centrally through the passageway defined through the charge detection cylinder CD. In some embodiments, as illustrated by example in FIG. 1, the charge detection cylinder CD is disposed within a field-free region FFR of a ground cylinder GC positioned between the ion mirrors M1, M2. A ground electrode GE1 of thickness D2 is defined at one end of the ground cylinder GC, and an external face of the ground electrode GE1 is illustratively spaced apart from the exposed face of the mirror electrode ME3 of the ion mirror M1 by a space S3 of length d1 (e.g., equal to the lengths of each of the spaces S1, S2). In alternate embodiments, the space S3 may have a length greater or lesser than d1. In any case, the ground electrode GE1 illustratively defines a conical aperture A3 therethrough which decreases linearly between the external and internal faces thereof from the same diameter P1 of the passageway defined through the mirror electrodes ME1-ME6 at the external face of GE1 to a reduced diameter P4 at the internal face of GE1. Another ground electrode GE2 also of thickness D2 is defined at an opposite end of the ground cylinder GC, and an external face of the ground electrode GE2 is illustratively spaced apart from the exposed face of the mirror electrode ME4 of the ion mirror M2 by a space S3 of length d1. In alternate embodiments, the space S3 may have a length greater or lesser than the length d1. In any case, the ground electrode GE2 also illustratively defines a conical aperture A4 therethrough which decreases linearly between the external and internal faces thereof from the same diameter P1 of the passageway defined through the mirror electrodes ME1-ME6 to the diameter P4 such that the ground electrodes GE1 and GE2 are identically configured. The internal or inner faces of the ground electrodes GE1 and GE2 are illustratively spaced apart from one another by a distance D4 which defines the length of the field free region FFR. In the illustrated embodiment, the charge detection cylinder CD is centered axially within the field free region FFR such that the opposite ends of the charge detection cylinder CD are each spaced apart from an inner face of a respective one of the ground electrodes GE1, GE2 by a distance d2.

The ELIT 10 further includes a nozzle N1 positioned between the ground electrode GE1 and the charge detection cylinder CD and a nozzle N2 positioned between the charge detection cylinder CD and the ground electrode GE2, as illustrated by example in FIG. 1. The nozzles N1, N2 each have a length d3 that is less than the distance d2 between the charge detection cylinder CD and the respective ground electrode GE1, GE2. In alternate embodiments, the length d3 may be equal to the distance d2. The nozzle N1 extends outwardly from an internal face of the ground electrode GE1 to a position adjacent the charge detection cylinder CD. An internal face of the nozzle N1 adjacent the charge detection cylinder CD is a distance d4 from the charge detection cylinder CD. The distance d2 between the ground electrode GE1 and the charge detection cylinder CD is, thus, the length d3 of the nozzle N1 plus the distance d4 between the nozzle N1 and the charge detection cylinder CD. The nozzle N2 extends outwardly from an internal face of the ground electrode GE2 to a position adjacent the charge detection cylinder CD. An internal face of the nozzle N2 adjacent the charge detection cylinder CD is the distance d4 from the charge detection cylinder CD. The distance d2 between the ground electrode GE2 and the charge detection cylinder CD is, thus, the length d3 of the nozzle N2 plus the distance d4 between the nozzle N2 and the charge detection cylinder CD.

The nozzles N1, N2 illustratively each define a cylindrical passageway axially therethrough of diameter P4. The diameter P4 of the passageway of the nozzles N1, N2 is equal to the diameter P4 of the aperture A3 of the ground electrode GE1 and the aperture A4 of the ground electrode GE2. In some embodiments, the passageway of the nozzles N1, N2 has a different diameter than the diameter P4 of the aperture A3 of the ground electrode GE1 and the aperture A4 of the ground electrode GE2.

The nozzles N1, N2 are oriented relative to the ion mirrors M1, M2 such that the longitudinal axis C extending centrally through the passageways defined through the ion mirrors M1, M2 also extends centrally through the passageway defined through the nozzles N1, N2. An external face of the nozzle N1 is illustratively abutting the internal face of the ground electrode GE1 such that the passageway defined through the ground electrode GE1 having a diameter P4 at the internal face thereof is aligned with the passageway of the nozzle N1 having the diameter P4. An external face of the nozzle N2 is illustratively abutting the internal face of the ground electrode GE2 such that the passageway defined through the ground electrode GE2 having a diameter P4 at the internal face thereof is aligned with the passageway of the nozzle N2 having the diameter P4. The charge detection cylinder CD has a wall thickness of D5 as shown in FIG. 1. In some embodiments, the nozzles N1, N2 each have a wall thickness of D6 that is equal to the wall thickness D5 of the charge detection cylinder CD. In some embodiments, the nozzles N1, N2 each have a wall thickness of D6 that is less than the wall thickness D5 of the charge detection cylinder CD. In some embodiments, the nozzles N1, N2 each have a wall thickness of D6 that is greater than the wall thickness D5 of the charge detection cylinder CD.

The total axial length, TL, of the ELIT 10, not including the end plates or covers PL1, PL2, is TL=6D1+2D2+D3+6d1+2d2. In one specific example embodiment, the various dimensional parameters described above may have the numerical values set forth in the following TABLE I, although it will be understood that such numerical values are provided only by way of example and should not be considered limiting in any way.

TABLE I

| Dimensional | Numerical Value |
|---|---|
| Parameter | (millimeters) |
| D1 | 4.57 |
| D2 | 3.81 |
| D3 | 57.9 |
| D4 | 76.2 |
| D5 | 1.27 |
| D6 | 1.27 |
| d1 | 0.127 |
| d2 | 9.15 |
| d3 | 8.763 |
| d4 | 0.015 |
| P1 | 13.97 |
| P2 | 3.0 |
| P3 | 6.35 |
| P4 | 3.3 |

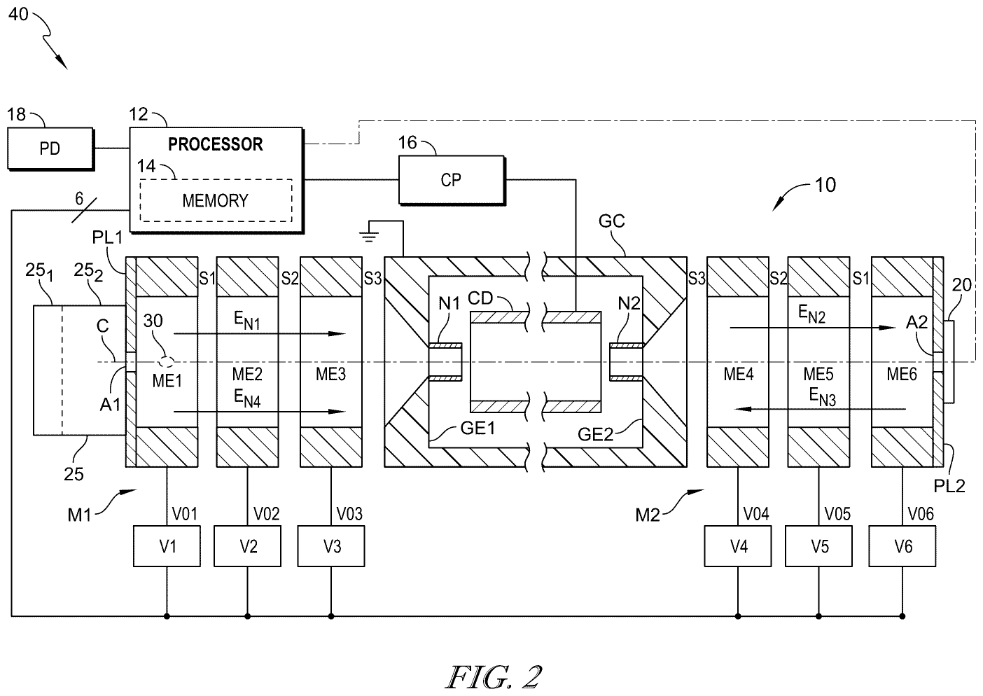

Although the mirror electrodes ME1-ME6 of the ion mirrors M1, M2 and the nozzles N1, N2 are illustrated in FIGS. 1 and 2 and described above as defining cylindrical passageways therethrough of diameter P1, P4, respectively, it will be understood that in alternate embodiments one or more of the mirror electrodes ME1-ME6 or at least one of the nozzles N1, N2 may define non-cylindrical passageways therethrough such that the variable P1, P4 for such one or more mirror electrodes or such at least one nozzles represents a cross-sectional area and profile that is not circular. Likewise, although the charge detection cylinder CD is illustrated in FIGS. 1 and 2 and described above as defining a cylindrical passageway therethrough of diameter P3, it will be understood that in alternate embodiments the passageway defined through the charge detection cylinder CD may be non-cylindrical such that the variable P3 in such embodiments represents a cross-sectional area and profile that is not circular. In still other embodiments, regardless of the shape of the cross-sectional profiles, the cross-sectional areas of the passageways defined through the mirror electrodes ME1-ME3 may be different from those of the passageways defined through the mirror electrodes ME4-ME6.

Referring now to FIG. 2, the ELIT 10 of FIG. 1 is shown along with an ion source 25 and electrical control and measurement components coupled thereto to form an embodiment of a charge detection mass spectrometer (CDMS) 40. In the illustrated embodiment, three voltage sources, V1, V2, and V3, are electrically connected to the mirror electrodes ME1, ME2, ME3, respectively, of the ion mirror M1, and three voltage sources V4, V5, V6 are electrically connected to the mirror electrodes ME4, ME5, ME6 of the ion mirror M2, respectively. In some alternate embodiments, one or more of the mirror electrodes ME1, ME2, ME3 of the ion mirror M1 may share a voltage source with (a) corresponding one(s) of the mirror electrodes ME4, ME5, ME6 of the ion mirror M2. In any case, each voltage source V1-V6 is illustratively a switchable DC voltage source which may be programmed or controlled to selectively switch between programmable or controllable DC voltage levels. In the illustrated embodiment, the voltage sources V1-V6 are shown electrically connected to a conventional processor 12 including a memory 14 having instructions stored therein which, when executed by the processor 12, cause the processor 12 to control the voltage sources V1-V6 to selectively produce desired DC output voltages VO1-VO6 respectively. In some alternative embodiments, one or more of the voltage sources V1-V6 may be programmable to selectively produce desired output voltages. In other alternative embodiments, one or more of the voltage sources V1-V6 may be configured to produce a time-varying output voltage of any desired shape. It will be understood that more or fewer voltage sources may be electrically connected to the mirror electrodes M1, M2 in alternate embodiments. In any case, the ground cylinder GC is illustratively grounded such that the ground electrodes GE1, GE2 are both at ground potential. In some alternate embodiments, either or both of the ground electrodes GE1, GE2 may be set to any desired DC reference potential, and in other alternate embodiments either or both of the ground electrodes GE1, GE2 may be electrically connected to a switchable DC or time-varying voltage source.

The charge detection cylinder CD is electrically connected to a signal input of a conventional charge pre-amplifier 16 (CP) having a signal output electrically connected to the processor 12. As an ion within the ELIT 10 oscillates back and forth between the ion mirrors M1, M2 as briefly described above, it passes each time through the charge detection cylinder CD where it induces at least a portion of its charge onto the charge detection cylinder CD. The charge pre-amplifier 16 is illustratively responsive to each such induced charge detected at its input to produce a corresponding amplified charge detection signal which is provided as an input to the processor 12. The processor 12 is illustratively operable to receive and digitize such charge detection signals produced by the charge pre-amplifier 16, and to store the digitized charge detection signals in the memory 14. The processor 12 is further illustratively coupled to one or more peripheral devices 18 for providing signal input(s) to the processor 12 and/or to which the processor 12 provides signal output(s). In some embodiments, the peripheral devices 18 include at least one of a conventional display monitor, a printer, and/or other output device, and the memory 14 has instructions stored therein which, when executed by the processor 12, cause the processor 12 to control one or more such output peripheral devices 18 to display and/or record analyses of the stored, digitized charge detection signals. In some embodiments, a conventional microchannel plate detector 20 may be disposed at the ion outlet of the ELIT 10 and electrically connected to the processor 12 as shown by dashed-line representation in FIG. 2, and in such embodiments the microchannel plate detector 20 is operable to supply detection signals to the processor 12 corresponding to detected ions and/or neutrals.

As further illustrated in FIG. 2, an ion source 25 is coupled to the ion inlet of the ELIT 10, and the ion source 25 is configured to supply ions 30 to the ELIT 10 through the ion inlet A1 of the plate or cover PL1. In one example embodiment, the ion source 25 illustratively includes a source of ions 25₁ operatively coupled to a mass spectrometer 25₂. In this example embodiment, the source of ions 25₁ is illustratively configured and operable in a conventional manner to generate and supply ions to the mass spectrometer 25₂, and the mass spectrometer 25₂ is configured and operable in a conventional manner to separate ions as a function of ion mass-to-charge ratio such that ions 30 supplied to the ELIT 10 are those exiting the mass spectrometer 25₂. Conventionally, CDMS is a single-particle measurement technique in which charge and mass-to-charge ratio values are measured for individual charged particles, i.e., individual ions, and in which such measurements for multiple ions are then collected and used to produce mass and charge spectral information for the sample from which the ions are generated. In the CDMS 40 illustrated in FIG. 2 operating as such a single-particle measurement instrument, the ELIT 10 is illustratively controlled, as described in further detail below, in a manner which favors trapping therein of individual ions exiting the mass spectrometer 25₂. Charges induced on the charge detection cylinder CD, as the trapped ion oscillates in the ELIT 10 between the ion mirrors M1, M2, are detected by the charge preamplifier CP, and the corresponding charge detection signals produced by the charge preamplifier CP are processed by the processor 12 to determine the ion's charge and mass-to-charge ratio from which the ion's mass can then be computed.

In the example embodiment illustrated in FIG. 2 in which the ion source 25 includes a source of ions 25₁ coupled to an ion inlet of a mass spectrometer 25₂, the mass spectrometer 25₂ may be of any conventional design including, for example, but not limited to a time-of-flight (TOF) mass spectrometer, a reflectron mass spectrometer, a Fourier transform ion cyclotron resonance (FTICR) mass spectrometer, a quadrupole mass spectrometer, a multi-quadrupole mass spectrometer, a sector mass spectrometer, such as a magnetic sector mass spectrometer, or the like. The source of ions 25₁ may illustratively be or include any conventional ion source for supplying ions to the mass spectrometer 25₂ including for example, but not limited to, one or any combination of at least one ion generating device such as an electrospray ionization source, a matrix-assisted laser desorption ionization (MALDI) source or the like. In some embodiments, the ion source 25 may further illustratively include other ion processing instruments or stages prior to, i.e., upstream of, the source of ions 251, between the source of ions 25₁ and the mass spectrometer 25₂ and/or between the mass spectrometer 25₂ and the ELIT 10. Examples of such other ion processing instruments or stages may include, but are not limited to, one or any combination of one or more molecular separation instruments configured to separate ions over time as a function of at least one molecular characteristic, such as an ion mobility spectrometer, another mass spectrometer, a liquid or gas chromatograph, or the like, one or more instruments for collecting and/or storing ions (e.g., one or more quadrupole, hexapole and/or other ion traps), one or more instruments for filtering ions (e.g., according to one or more molecular characteristics such as ion mass, charge, ion mass-to-charge, ion mobility, ion retention time and the like), one or more instruments for fragmenting or otherwise dissociating ions, one or more instruments for normalizing or shifting ion charge states, and the like. In any case, as briefly described above and as illustrated by example in FIG. 2, at least one ion 30 introduced into the ELIT 10 from the ion source 25 is made to oscillate between the ion mirrors M1, M2, each time passing through the charge detector CD and the nozzles N1, N2, and the resulting charges induced by the at least one ion 30 on the charge detection cylinder CD are detected by the charge preamplifier 16. The corresponding charge detection signals produced by the charge preamplifier CP are then processed by the processor 12 to determine ion mass-to-charge ratio and ion mass values. The at least one ion 30 may be a single ion 30 or multiple ions 30.

The nozzle N1 directs the at least one ion 30 from the conical aperture A3 of the ground electrode GE1 into the charge detection cylinder CD (and from the charge detection cylinder CD to the conical aperture A3 of the ground electrode GE1), and the nozzle N2 directs the at least one ion 30 from the conical aperture A4 of the ground electrode GE2 into the charge detection cylinder CD (and from the charge detection cylinder CD to the conical aperture A4 of the ground electrode GE1). The nozzles N1, N2 help to direct the at least one ion 30 along the longitudinal axis C extending centrally through the ELIT 10. The nozzles N1, N2 also help to reduce capacitive coupling between the ground electrodes GE1, GE2 and the charge detection cylinder CD. Capacitive coupling between the charge detection cylinder CD and the ground electrodes GE1, GE2 contributes to input capacitance of the charge preamplifier 16. Input capacitance is a major source of electrical noise for low noise charge preamplifiers without a feedback resistor. Reducing the capacitance reduces the noise, which in turn reduces the time required to make accurate charge measurements. In some embodiments, a capacitance on the charge detection cylinder CD is about 2.4 pF. A capacitance on a charge detection cylinder without the nozzles N1, N2 is about 3.1 pF. The nozzles N1, N2, thus, reduce the capacitance on the charge detection cylinder CD by about 22%. In some embodiments, the nozzles N1, N2 reduce the capacitance on the charge detection cylinder CD by about 20% to about 30%. In some embodiments, the nozzles N1, N2 reduce the capacitance on the charge detection cylinder CD by about 30% to about 50%.

The nozzles N1, N2 have a relatively small outer diameter (similar to the diameter P4 of the passageway) as compared to the outer diameter of the charge detection cylinder CD (similar to the diameter P3 of the passageway). As such, the relatively small outer diameter of the nozzles N1, N2 reduces the amount of material adjacent the charge detection cylinder CD. Thus, as the amount of material is reduced, the capacitive coupling is also reduced. Minimizing capacitive coupling reduces noise detected by the charge preamplifier 16. Reduced noise improves the m/z and charge measurements.

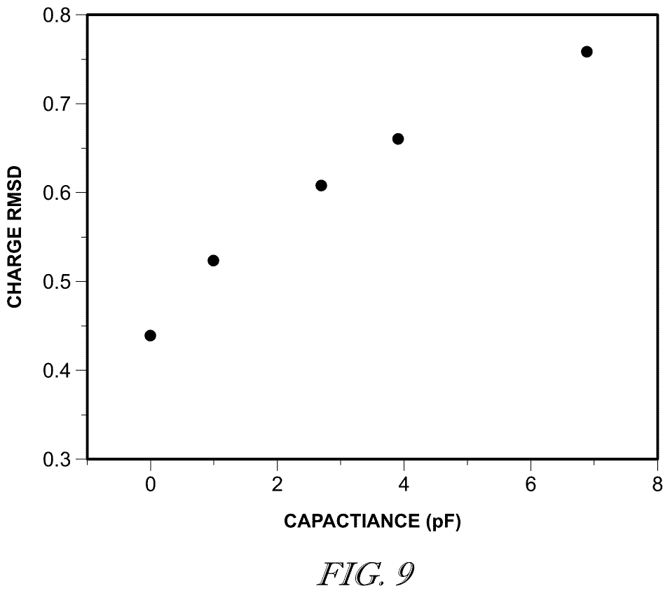

Referring to FIG. 9, a plot of charge RMSD is shown as a function of input capacitance of the charge preamplifier 16 as determined from the analysis of a 100 ms square wave signal. A capacitance of 0 pF refers to no additional capacitance added beyond a baseline level. Any increase in capacitance refers to capacitance added via a variable capacitor. The reduction in the capacitance due to the nozzles N1, N2 results in a reduction of the charge RMSD from 0.62 e to 0.56 e. Thus, the charge RMSD has about a 10% improvement due to the nozzles N1, N2. The nozzles N1, N2 also result in about a 20% reduction in the measurement time necessary to achieve a charge RMSD of less than 0.2 e, where ions may be assigned to the correct charge state with a low error rate.

The nozzles N1, N2 also help to shield the charge detection cylinder CD from spurious pulses, shifts, and/or drifts in the potentials on the electrodes ME1-ME6 of the ion mirrors M1, M2. Potentials on the ion mirrors M1, M2 are initially set relatively low during a transmission mode, as will be discussed in greater detail below, to allow the at least one ion 30 to enter the ELIT 10. The potentials are then switched to a trigger trapping mode, which will be discussed in greater detail below, to trap the at least one ion 30 in the ELIT 10. The rapid change in the potentials cause a large signal to appear on the charge detection cylinder CD. One way of minimizing this signal is by applying a counter pulse to an antenna mounted on the field free region FFR. However, with the nozzles N1, N2, the pickup is reduced and the need for counter pulsing is diminished.

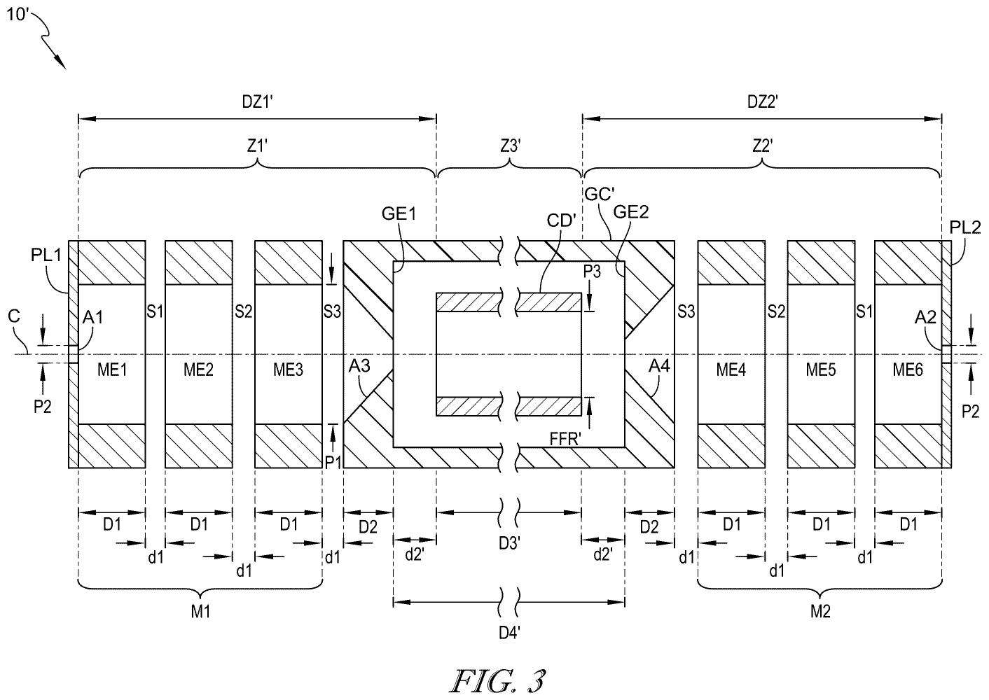

Referring to FIG. 3, a simplified block diagram is shown of another embodiment of an electrostatic linear ion trap (ELIT) 10′. As compared to the ELIT 10, the nozzles N1, N2 are omitted in the ELIT 10′. The ELIT 10′ is substantially similar to the ELIT 10. The description of the ELIT 10 is incorporated by reference to apply to the ELIT 10′, except in instances when it conflicts with the specific description of the ELIT 10′.

A charge detector CD' in the form of an electrically conductive cylinder of length D3′ is positioned between the spaced apart ion mirrors M1, M2. The charge detector CD′ is oriented relative to the ion mirrors M1, M2 such that the longitudinal axis C extending centrally through the passageways defined through the ion mirrors M1, M2 also extends centrally through the passageway defined through the charge detector CD′. In some embodiments, as illustrated by example in FIG. 3, the charge detection cylinder CD′ is disposed within a field-free region FFR′ of a ground cylinder GC′ positioned between the ion mirrors M1, M2. The internal or inner faces of the ground electrodes GE1 and GE2 are illustratively spaced apart from one another by a distance D4′ which defines the length of the field free region FFR′. In the illustrated embodiment, the charge detection cylinder CD′ is centered axially within the field free region FFR′ such that the opposite ends of the charge detection cylinder CD′ are each spaced apart from an inner face of a respective one of the ground electrodes GE1, GE2 by a distance d2′.

The total axial length, TL, of the ELIT 10′, not including the end plates or covers PL1, PL2, is TL=6D1+2D2+D3′+6d1+2d2′. In one specific example embodiment, the various dimensional parameters described above may have the numerical values set forth in the following TABLE II, although it will be understood that such numerical values are provided only by way of example and should not be considered limiting in any way.

TABLE II

| Dimensional | Numerical Value |
|---|---|
| Parameter | (millimeters) |
| D1 | 4.57 |
| D2 | 3.81 |
| D3′ | 49.28 |
| D4′ | 76.2 |
| d1 | 0.127 |
| d2′ | 13.46 |
| P1 | 13.97 |
| P2 | 3.0 |
| P3 | 6.35 |

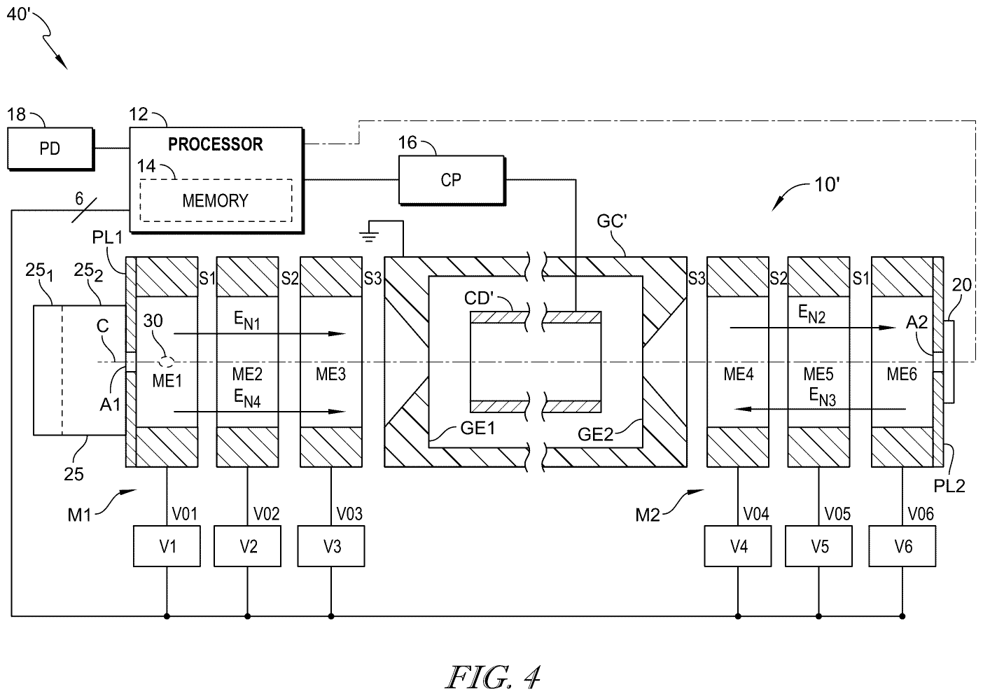

Referring now to FIG. 4, the ELIT 10′ of FIG. 3 is shown along with an ion source 25 and electrical control and measurement components coupled thereto to form an embodiment of a charge detection mass spectrometer (CDMS) 40′. In the illustrated embodiment, three voltage sources, V1, V2, and V3, are electrically connected to the mirror electrodes ME1, ME2, ME3, respectively, of the ion mirror M1, and three voltage sources V4, V5, V6 are electrically connected to the mirror electrodes ME4, ME5, ME6 of the ion mirror M2, respectively. Each voltage source V1-V6 is illustratively a switchable DC voltage source which may be programmed or controlled to selectively switch between programmable or controllable DC voltage levels. In the illustrated embodiment, the voltage sources V1-V6 are shown electrically connected to a conventional processor 12 including a memory 14 having instructions stored therein which, when executed by the processor 12, cause the processor 12 to control the voltage sources V1-V6 to selectively produce desired DC output voltages VO1-VO6 respectively.

The charge detection cylinder CD′ is electrically connected to a signal input of a conventional charge pre-amplifier 16 (CP) having a signal output electrically connected to the processor 12. As an ion within the ELIT 10′ oscillates back and forth between the ion mirrors M1, M2 as briefly described above, it passes each time through the charge detection cylinder CD′ where it induces at least a portion of its charge onto the charge detection cylinder CD′. The charge pre-amplifier 16 is illustratively responsive to each such induced charge detected at its input to produce a corresponding amplified charge detection signal which is provided as an input to the processor 12. The processor 12 is illustratively operable to receive and digitize such charge detection signals produced by the charge pre-amplifier 16, and to store the digitized charge detection signals in the memory 14. The processor 12 is further illustratively coupled to one or more peripheral devices 18 for providing signal input(s) to the processor 12 and/or to which the processor 12 provides signal output(s). In some embodiments, the peripheral devices 18 include at least one of a conventional display monitor, a printer, and/or other output device, and the memory 14 has instructions stored therein which, when executed by the processor 12, cause the processor 12 to control one or more such output peripheral devices 18 to display and/or record analyses of the stored, digitized charge detection signals. In some embodiments, a conventional microchannel plate detector 20 may be disposed at the ion outlet of the ELIT 10′ and electrically connected to the processor 12 as shown by dashed-line representation in FIG. 4, and in such embodiments the microchannel plate detector 20 is operable to supply detection signals to the processor 12 corresponding to detected ions and/or neutrals.

As illustrated by example in FIG. 4, at least one ion 30 introduced into the ELIT 10′ from the ion source 25 is made to oscillate between the ion mirrors M1, M2, each time passing through the charge detector CD′, and the resulting charges induced by the at least one ion 30 on the charge detection cylinder CD′ are detected by the charge preamplifier 16. The corresponding charge detection signals produced by the charge preamplifier 16 are then processed by the processor 12 to determine ion mass-to-charge ratio and ion mass values. The at least one ion 30 may be a single ion 30 or multiple ions 30.

The at least one ion 30 is directed from the conical aperture A3 of the ground electrode GE1 into the charge detection cylinder CD' (and from the charge detection cylinder CD′ to the conical aperture A3 of the ground electrode GE1), and the at least one ion 30 is directed from the conical aperture A4 of the ground electrode GE2 into the charge detection cylinder CD′ (and from the charge detection cylinder CD′ to the conical aperture A4 of the ground electrode GE1). The relatively large distance d2′ between the ground electrodes GE1, GE2 and the charge detection cylinder CD′ helps to reduce capacitive coupling between the ground electrodes GE1, GE2 and the charge detection cylinder CD′. Capacitive coupling between the charge detection cylinder CD′ and the ground electrodes GE1, GE2 contributes to input capacitance of the charge preamplifier 16. Input capacitance is a major source of electrical noise for low noise charge preamplifiers without a feedback resistor. Reducing the capacitance reduces the noise, which in turn reduces the time required to make accurate charge measurements.

The relatively large distance d2′ reduces the amount of material adjacent the charge detection cylinder CD′. Thus, as the amount of material is reduced, the capacitive coupling is also reduced. Minimizing capacitive coupling reduces noise detected by the charge preamplifier 16. Reduced noise improves the m/z and charge measurements.

As will be described in greater detail below, the at least one ion 30 is trapped within the ELIT 10, 10′ and made to oscillate between the ion mirrors M1, M2 thereof by selectively controlling the voltage sources V1-V6 to establish electric fields within and between the mirror electrodes ME1-ME3 of each ion mirror M1, M2 for selectively transmitting ions therethrough and for selectively reflecting ions therefrom back toward the opposite ion mirror M1, M2.

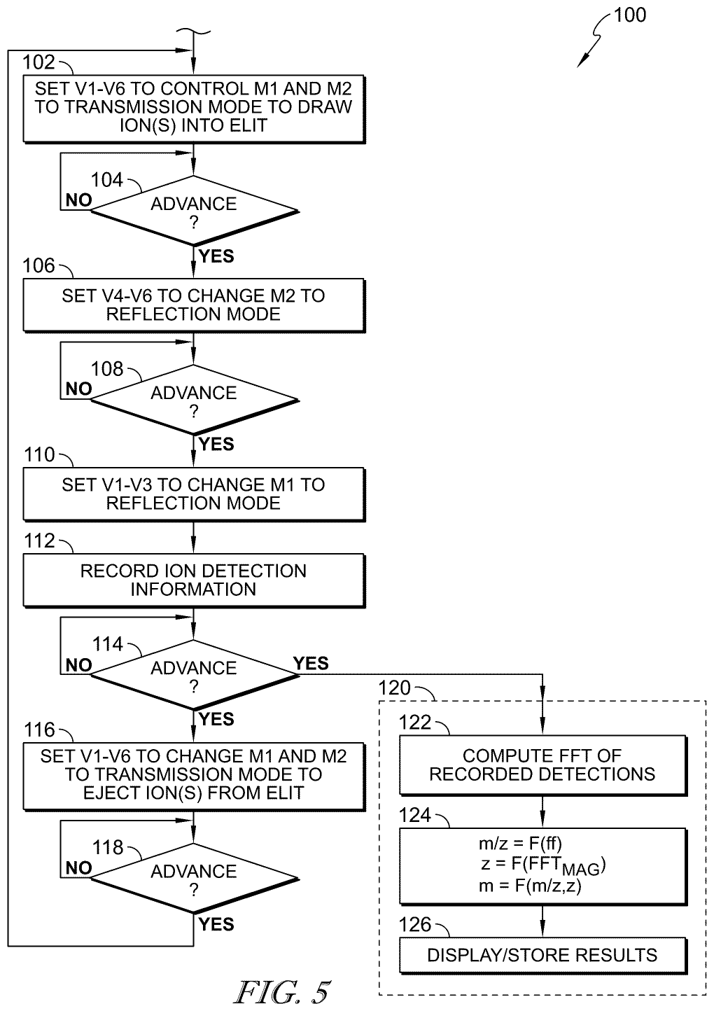

Referring now to FIG. 5, a simplified flowchart is shown illustrating an embodiment of a process 100 for controlling the voltage sources V1-V6 to trap at least one ion 30 supplied by the ion source 25 within the ELIT 10, 10′ and to cause the trapped at least one ion 30 to oscillate back and forth between the ion mirrors M1, M2, and for processing recorded charge detection signals to determine ion charge, ion mass-to-charge ratio, and ion mass values. In the illustrated embodiment, the process 100 is illustratively stored in the memory 14 in the form of instructions which, when executed by the processor 12, cause the processor 12 to perform the stated functions. In alternate embodiments in which one or more of the voltage sources V1-V6 is/are programmable independently of the processor 12, one or more aspects of the process 100 may be executed in whole or in part by the one or more of the programmable voltage sources V1-V6. For purposes of this disclosure, however, the process 100 will be described as being executed solely by the processor 12. The process 100 will further be described as operating on a positively charged at least one ion 30, although it will be understood that the process 100 may alternatively operate on a negatively charged ion.

With reference to FIGS. 2-4, the process 100 begins at step 102 where the processor 12 is operable to control one or more of the voltage sources V1-V6 to set the voltages VO1-VO6 in a manner which causes each of the ion mirrors M1 and M2 to operate in a “transmission mode” in which each of the ion mirrors M1, M2 operates to pass ions therethrough. Such control of the ion mirrors M1 and M2 to their respective transmission modes causes the at least one ion 30 supplied by the ion source 25 to pass completely through the ELIT 10, 10′ as at least partially depicted in FIGS. 2 and 4. Illustratively, the output voltages VO1-VO3 produced by the voltage sources V1-V3, respectively, are controlled by the processor 12 at step 102 to establish a net “transmission” electric field EN1 in the ion mirror M1 which focuses the at least one ion 30 passing into the ion mirror M1 toward the longitudinal axis C extending centrally through the ELIT 10, 10′. As a result of this focusing effect of the ion transmission electric field EN1, the at least one ion 30 exiting ion mirror M1 attains a narrow trajectory through the charge detector CD, CD′, i.e., close to the longitudinal axis C, and into the ion mirror M2. The output voltages VO4-VO6 produced by the voltage sources V4-V6, respectively, are likewise illustratively controlled at step 102 to establish a net “transmission” electric field E_{N2} in the ion mirror M2, identical or similar to the ion transmission electric field E_{N1}, which focuses the at least one ion 30 toward the longitudinal axis C such that the at least one ion 30 passes through the ion mirror M2 and then through the exit aperture A2 defined in the plate PL2.

Following step 102, the process 100 advances to step 104 where the processor 12 is operable to pause and determine when to advance to step 106. In one embodiment, the processor 12 is operable at step 104 to pause for a predefined or programmable time period to allow ions exiting the ion source 25 to enter and pass through the ELIT 10, 10′. As one non-limiting example, the selected time period which the processor 12 spends at step 104 before moving on to step 106 is on the order of 1 millisecond (ms), although it will be understood that such selected time period may, in other embodiments, be greater than 1 ms or less than 1 ms. Until the selected time period has elapsed, the process 100 follows the NO branch of step 104 and loops back to the beginning of step 104. After passage of the selected time period, the process 100 follows the YES branch of step 104 and advances to step 106. In some alternate embodiments of step 104, such as in embodiments which include the microchannel plate detector 20, the processor 12 may be operable to control the voltage sources V1-V6 to hold the ion mirrors M1, M2 in their transmission modes until at least one ion 30 is detected at the microchannel plate detector 20. Until such detection, the process 100 follows the NO branch of step 104 and loops back to the beginning of step 104.

Following the YES branch of step 104, the processor 12 is operable at step 106 to control the voltage sources V4-V6 to set the output voltages VO4-VO6 in a manner which changes or switches the operation of the ion mirror M2 from transmission mode of operation to a “reflection mode” of operation in which the ion mirror M2 operates to “reflect” an ion contained therein back toward the ion mirror M1 (and through the charge detector CD, CD′) by first decelerating and stopping the ion, and then accelerating the ion back in the opposite direction while focusing the ion toward the longitudinal axis C such that the ion passes in a narrow trajectory about the longitudinal axis C from the ion mirror M2 back toward the ion mirror M1. Illustratively, the output voltages VO4-VO6 produced by the voltage sources V4-V6, respectively, are controlled by the processor 12 at step 106 to establish a net “reflection” electric field E_{N3} in the ion mirror M2 oriented to reflect the at least one ion 30 entering therein from the charge detector CD, CD′ back toward the ion mirror M1 (and through the charge detector CD, CD′) as illustrated by example in FIGS. 2 and 4. Illustratively, the output voltages VO1-VO3 produced by the voltage sources V1-V3, respectively, are unchanged at step 106 so that the ion mirror M1 remains in its transmission mode to allow one or more additional ions 30 to enter into the ion mirror M1 from the mass spectrometer 25 or other ion source. In such embodiments, the process 100 advances from step 106 to step 108 where the processor 12 is operable to pause and determine when to advance to step 110.

In one embodiment of step 108, the ELIT 10, 10′ is illustratively controlled in a “random trapping mode” in which the ion mirror M2 is held in the reflection mode and the ion mirror M1 is held in the transmission mode for a selected time period as one or more ions 30 enter the ion mirror M1 from the ion source 25. As one non-limiting example, the selected time period which the processor 12 spends at step 108 before moving on to step 110 is on the order of 1 millisecond (ms), although it will be understood that such selected time period may, in other embodiments, be greater than 1 ms or less than 1 ms. Until the selected time period has elapsed, the process 100 follows the NO branch of step 108 and loops back to the beginning of step 108. After passage of the selected time period, the process 100 follows the YES branch of step 108 and advances to step 110.

In some alternate embodiments of step 108, the ELIT 10, 10′ may illustratively be controlled by the processor 12 in a first version of a “trigger trapping mode” in which the ion mirror M1 is held in the transmission mode and the ion mirror M2 is held in the reflection mode until at least one ion 30 is detected by the charge detector CD, CD′. Until such detection, the process 100 follows the NO branch of step 108 and loops back to the beginning of step 108. Detection by the processor 12 of the ion by the charge detector CD, CD′ serves as a trigger event which causes the processor 12 to follow the YES branch of step 108 and advance to step 110 of the process 100. In this version of the trigger trapping mode, the detected ion serving as the trigger event may be an ion entering the ELIT 10, 10′ from the ion source 25 and passing through the charge detection cylinder CD, CD′ toward the ion mirror M2, or an ion reflected by the ion mirror M2 and passing back through the charge detection cylinder CD, CD′ toward the ion mirror M1.

In a second version of the “trigger trapping mode,” steps 104 and 106 may be omitted, and detection by the processor 12 of an ion by the charge detector CD, CD′ at step 108 again serves as a trigger event which causes the processor 12 to follow the YES branch of step 108 and advance to step 110. In this version of the trigger trapping mode, the ion mirrors M1, M2 are both in transmission mode such that the detected ion serving as the trigger event may only be an ion entering the ELIT 10, 10′ from the ion source 25 and passing through the charge detection cylinder CD, CD′ toward the ion mirror M2.

Following the YES branch of step 108 in any of the trapping modes described above, the processor 12 is operable at step 110 to control the voltage sources V1-V3 to set the output voltages VO1-VO3 in a manner which changes or switches the operation of the ion mirror M1 from transmission mode of operation to the reflection mode of operation in which the ion mirror M1 operates to reflect an ion contained therein back toward the ion mirror M2 (and through the charge detector CD). Illustratively, the output voltages VO1-VO1 produced by the voltage sources V1-V3, respectively, are controlled by the processor 12 at step 110 to establish a net “reflection” electric field E_{N4} in the ion mirror M1, which is identical or similar to the ion reflection electric field E_{N3} established within the ion mirror M2, and which is oriented to reflect the at least one ion 30 entering therein from the charge detector CD, CD′ back toward the ion mirror M2 (and through the charge detector CD, CD′) as illustrated by example in FIGS. 2 and 4. The output voltages VO4-VO6 produced by the voltage sources V4-V6 are unchanged at step 110 so that the net electric field E_{N3} remains in the ion mirror M2 so as to maintain the ion mirror M2 in the reflection mode of operation. At step 110, the at least one ion 30 is trapped within the ELIT 10, 10′, and with both of the ion mirrors M1 and M2 operating in the reflection modes the at least one ion 30 traversing the length of the ELIT 10, 10′ is reflected by each of the respective ion reflection electric fields E_{N3} and E_{N4} in a manner which enables the at least one ion 30 to oscillate back and forth between the ion mirrors M1 and M2, each time passing through the charge detector CD, CD′ along a narrow trajectory about the central longitudinal axis C of the ELIT 10, 10′.

Following step 110, the process 100 advances to step 112 where, as the ion is oscillating within the ELIT 10, 10′ back and forth between the ion mirrors M1, M2 during a “detection phase,” detection by the charge preamplifier CP of the charge induced on the charge detector CD, CD′ by each passage of the ion therethrough (hereinafter referred to as a “charge detection event”) is recorded, i.e., stored in the memory 14, by the processor 12. Illustratively, the detection information recorded at step 112 includes amplitude and timing information, i.e., the amplitudes of each charge detection signal as well as the time of each charge detection signal relative to a reference time and/or relative to a time of a previous charge detection signal.

Following step 112, the process 100 advances to step 114 where the processor 12 is operable to pause and determine when to advance to step 114. In one embodiment, the processor 12 is configured, i.e. programmed, to allow the ion(s) to oscillate through the ELIT 10, 10′ back and forth between the ion mirrors M1, M2 during the detection phase for a selected time period during which charge detection events are recorded by the processor 12. As one non-limiting example, the selected time period which the processor 12 spends in the detection phase at step 114 before moving on to step 116 is on the order of 100 millisecond (ms), although it will be understood that such selected time period may, in other embodiments, be greater than 100 ms or less than 100 ms. Until the selected time period has elapsed, the process 100 follows the NO branch of step 114 and loops back to the beginning of step 114. After passage of the selected time period, the process 100 follows the YES branch of step 114 and advances to step 116. In some alternate embodiments of step 114, the ELIT 10, 10′ may illustratively be controlled by the processor 12 to allow the ion(s) to oscillate back in forth through the charge detector CD, CD′ during the detection phase a selected number of times during which charge detection events are recorded by the processor 12. Until the processor counts the selected number charge detection events, the process 100 follows the NO branch of step 114 and loops back to the beginning of step 114. Detection by the processor 12 of the selected number of charge detection events serves as a trigger event which causes the processor 12 to follow the YES branch of step 114 and advance to step 116 of the process 100.

Following the YES branch of step 114, the processor 12 is operable at step 116 to control the voltage sources V1-V6 to set the output voltages VO1-VO6 in a manner which changes or switches the operation of both of the ion mirrors M1 and M2 from reflection mode of operation to the transmission mode of operation in which the ion mirrors M1, M2 each operate to allow passage of ions therethrough. Illustratively, the output voltages VO1-VO6 produced by the voltage sources V1-V6, respectively, are controlled by the processor 12 at step 116 to re-establish net electric fields E_{N1} and E_{N2} in the ion mirrors M1, M2 as described above and as illustrated in FIGS. 2 and 4. Thereafter at step 118, the processor 12 is programed to pause for a selected time period to allow the ions contained within the ELIT 10, 10′ to exit. As one non-limiting example, the selected time period which the processor 12 spends at step 118 before looping back to step 102 to restart the process 100 is on the order of 1 millisecond (ms), although it will be understood that such selected time period may, in other embodiments, be greater than 1 ms or less than 1 ms. Until the selected time period has elapsed, the process 100 follows the NO branch of step 118 and loops back to the beginning of step 118. After passage of the selected time period, the process 100 follows the YES branch of step 118 and loops back to step 102 to restart the process 100.

As described above, each detection by the charge preamplifier CP of a charge induced on the charge detector CD, CD′ by passage of an ion therethrough is referred to as a “charge detection event.” As the ion oscillates back and forth between the ion mirrors M1, M2, multiple charge detection events are recorded. The total number of oscillations allowed before the process 100 advances from step 114 to step 116, or the total time allowed between step 110 and advancement of the process 100 from step 114, is referred to an ion trapping event. By either definition, the at least one ion 30 oscillates back and forth between the ion mirrors M1, M2 for a “total trapping time” of an ion trapping event during which multiple charge detection events are recorded.

Following another YES branch of step 114, the process 100 additionally advances to step 120 to analyze the data collected during the ion trapping event just described. In the illustrated embodiment, the data analysis step 120 illustratively includes step 122 where the processor 12 is operable to compute a Fourier transform of the collected set of stored charge detection signals recorded during the ion trapping event. The processor 12 is illustratively operable to execute step 122 using any conventional digital Fourier transform (DFT) technique such as for example, but not limited to, a conventional Fast Fourier Transform (FFT) algorithm. Following step 122, the process 100 advances to step 124 where the processor 12 is operable to compute values of ion mass-to-charge ratio (m/z) and ion charge (z), each as a function of the computed FFT, and thereafter at step 126 the processor 12 is operable to store the computed results in the memory 14 and/or to control one or more of the peripheral devices 18 to display the results for observation and/or further analysis.

It is generally understood that the mass-to-charge ratio (m/z) of an ion 30 oscillating in an ELIT is inversely proportional to the square of the fundamental frequency ff of the oscillating ion 30 according to the equation:

m/z=C/ff²,

where C is a constant that is a function of the ion energy and also a function of the dimensions of the ELIT. Typically, C is determined using conventional ion trajectory simulations. In any case, the value of the ion charge, z, is proportional to the magnitude of the fundamental frequency of the FFT, taking into account the number of ion oscillation cycles. Ion mass, m, is then calculated as a product of m/z and z. In some cases, the magnitude(s) of one or more of the harmonic frequencies of the FFT may be added to the magnitude of the fundamental frequency for purposes of determining the ion charge, z.

Multiple, e.g., hundreds or thousands or more, ion trapping events are typically carried out for any particular sample from which the ions are generated by the ion source 25, and ion mass-to-charge, ion charge, and ion mass values are determined/computed for each such ion trapping event at step 120 of the process 100. The ion mass-to-charge, ion charge, and ion mass values for such multiple ion trapping events are, in turn, combined to form spectral information relating to the sample. Such spectral information may illustratively take different forms, examples of which include, but are not limited to, ion count vs. mass-to-charge ratio, ion charge vs. ion mass (e.g., in the form of an ion charge/mass scatter plot), ion count vs. ion mass, ion count vs. ion charge, or the like.

Generally, uncertainty in the determination of ion mass with an ELIT depends on the uncertainties in the m/z and z measurements. In the process 100 just described, the measured m/z values are inversely proportional to the square of the fundamental frequency, ff, and the measured charge values are proportional to the magnitude of the FFT fundamental frequency. It has been determined through simulation and experimentation that because the measured charge values are proportional to the magnitude of the fundamental frequency, ff, of the oscillating charge detection signal, uncertainty in the charge measurements can be reduced by increasing the signal-to-noise ratio of the fundamental frequency ff of the oscillating charge detection signal relative to one or more harmonics of the oscillating charge detection signal.

The oscillating charge detection signal just described is substantially a square-wave signal having a duty cycle, DC, defined as a ratio of the time spent by the at least one ion 30 in the charge detection cylinder CD, CD′ and the time spent by the at least one ion 30 traversing the entire ELIT during one oscillation cycle. In particular, and referring again to FIG. 1, the duty cycle, DC, is the ratio of the time spent by the at least one ion 30 in the zone Z3 and the time spent by the at least one ion 30 traversing the sum of the zones Z1 through Z3 during one oscillation cycle. The length DZ1 and DZ2 of each of the zones Z1 and Z2 is the same and is given by DZ1=DZ2=3D1+D2+3d1+d2, and the length of the zone Z3 is D3. The time spent by at least one ion 30 traversing the distance DZ1 of Z1 as the ion is reflected by M1 toward M2 is T_{DZ11}, the time spent by the at least one ion 30 passing through the distance D3 following reflection by M1 through DZ1 is T_{Z31}, and the time spent by the at least one ion 30 traversing the distance DZ2 of Z2 after emerging from the charge detector CD is T_{DZ21}.

Similarly, the time spent by the at least one ion 30 traversing the distance DZ2 of Z2 as the ion is reflected by M2 back toward M1 is T_{DZ22}, the time spent by the at least one ion 30 passing through the distance D3 following reflection by M2 through DZ2 is T_{Z32}, and the time spent by the at least one ion 30 traversing the distance DZ1 of Z1 after emerging from the charge detector CD is T_{DZ12}. The duty cycle for the ELIT 10 illustrated in FIG. 1 is thus DC=(T_{Z31}+T_{Z32})/(T_{DZ11}+T_{Z31}+T_{DZ21}+T_{DZ22}+T_{Z32}+T_{DZ12})

As for FIG. 3, the duty cycle, DC, is the ratio of the time spent by the at least one ion 30 in the zone Z3′ and the time spent by the at least one ion 30 traversing the sum of the zones Z1′ through Z3′ during one oscillation cycle. The length DZ1′ and DZ2′ of each of the zones Z1′ and Z2′ is the same and is given by DZ1′=DZ2′=3D1+D2+3d1+d2′, and the length of the zone Z3′ is D3′. The time spent by at least one ion 30 traversing the distance DZ1′ of Z1′ as the ion is reflected by M1 toward M2 is T_{DZ11}′, the time spent by the at least one ion 30 passing through the distance D3′ following reflection by M1 through DZ1′ is T_{Z31}′, and the time spent by the at least one ion 30 traversing the distance DZ2′ of Z2′ after emerging from the charge detector CD′ is T_{DZ21}′. Similarly, the time spent by the at least one ion 30 traversing the distance DZ2′ of Z2′ as the ion is reflected by M2 back toward M1 is T_{DZ22}′, the time spent by the at least one ion 30 passing through the distance D3′ following reflection by M2 through DZ2′ is T_{Z32}′, and the time spent by the at least one ion 30 traversing the distance DZ1′ of Z1′ after emerging from the charge detector CD′ is T_{DZ12}′. The duty cycle for the ELIT 10′ illustrated in FIG. 3 is thus DC=(T_{Z31}′+T_{Z32}′)/(T_{DZ11}′+T_{Z31}′+T_{DZ21}′+T_{DZ22}′+T_{Z32}′+T_{DZ12}′)

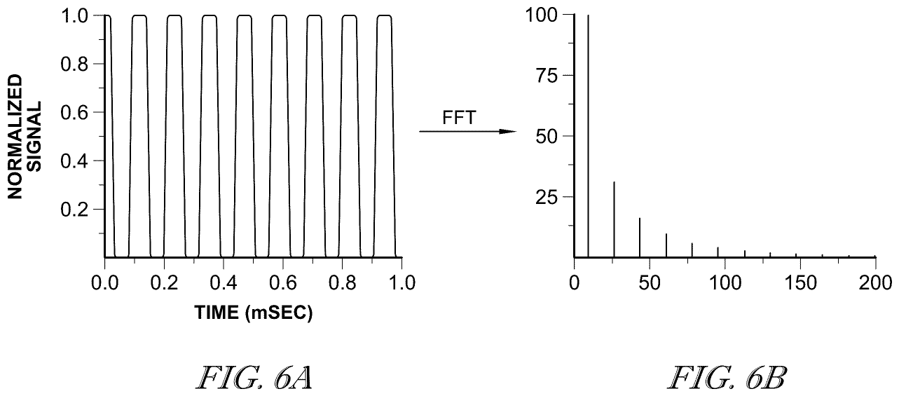

Referring to FIGS. 6A and 6B, it is generally understood in the signal waveform analysis art that square-wave signals having a 50% duty cycle produce only odd-valued signal harmonics. Applying this relationship to the control of the ELIT 10, 10′ illustrated in FIGS. 2 and 4, the output voltages VO1-VO6 of the voltage sources V1-V6 are illustratively controlled, taking into account the dimensions of the ELIT 10, 10′ illustrated in FIGS. 1 and 3, to establish the ion reflection electric fields, i.e., the electric field E_{N3} of the ion mirror M2 operating in reflection mode and the electric field E_{N4} also operating in reflection mode, in a manner which results in an oscillating charge detection signal having a duty cycle of approximately 50%. Because a 50% duty cycle square wave does not have any even-numbered harmonic frequency components, fewer harmonic frequency components will thus be included in the FFT computed by the processor 12 at step 114 as compared to that of an oscillating charge detection signal having a duty cycle other than 50%. Fewer such harmonic frequency components will yield a higher magnitude fundamental frequency peak and, since the ion charge value computed by the processor 12 at step 120 is proportional to the magnitude of the fundamental frequency ff, uncertainty in the ion charge measurement value will accordingly be reduced due to the increases in signal-to-noise ratio of the fundamental frequency peak relative to the harmonics. Operating the ELIT 10, 10′ with an oscillating charge detection signal having a duty cycle at or near 50% so as to include fewer harmonic frequency components, i.e., to specifically exclude even-numbered harmonics, further illustratively reduces effects of ion kinetic energy spread on the fundamental frequency so as to also reduce uncertainty in the ion mass-to-charge measurement values.

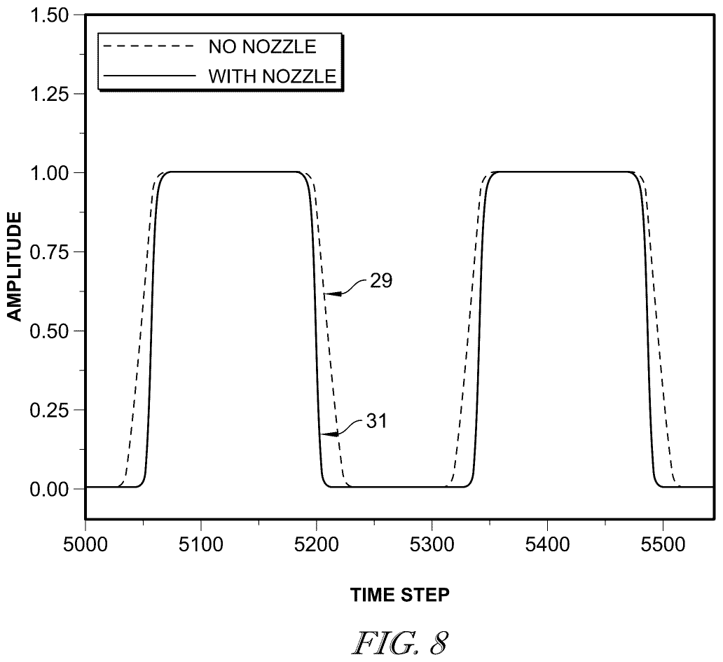

The shape of the signal waveform (i.e., how fast the signal rises and falls) also affects the harmonic ratios and may be adjusted to yield an optimized result from the FFT computed by the processor 12. The signal waveform may be optimized by adjusting the ground electrodes GE1, GE2. Without the nozzles N1, N2, a relatively large gap would be present between the ground electrodes GE1, GE2 and the charge detector CD. With such a relatively large gap, transitions from high and low states as the at least one ion 30 enters and exits the charge detector CD are not as sharp, as shown by line 29 in FIG. 8. In other words, the rise and fall times are relatively long. The signal rise and fall times may be reduced by the nozzles N1, N2, as shown by line 31 in FIG. 8. The nozzles N1, N2 shield the charge detector CD and prevent the charge detector CD from sensing a partial charge from the at least one ion 30 as the at least one ion 30 approaches the charge detector CD. The signal waveform with the nozzles N1, N2 is significantly squarer than the signal waveform without the nozzles N1, N2, with sharper rises and falls between the high and low states. The length d3 of the nozzles N1, N2, the diameter P4 of the passageway through the nozzles N1, N2, and an outer diameter of the nozzles N1, N2 may be optimized to control the shape of the signal waveform independently of the length D4 of the field free region FFR and the length D3 of the charge detector CD.

In order to achieve a 50% duty cycle with the ELIT 10, the time spent by at least one ion 30 traversing the distance DZ1+Z3+DZ2 must be equal to the time spent by the at least one ion 30 traversing the distance DZ2+Z3+DZ1 in the opposite direction. The duty cycle equation set forth in the previous paragraph thus simplifies to DC=T_{Z3}/(T_{DZ1}+T_{Z3}+T_{DZ2}), where T_{Z3} is the time spent by the at least one ion 30 traversing D3 in either direction, T_{DZ1} is the time spent by the at least one ion 30 travelling through each of DZ1 and DZ2 toward the other and T_{DZ2} is the time spent by the at least one ion 30 traveling into each of DZ1 and DZ2 prior to being reflected, i.e., prior to changing directions under the influence of the net electric fields E_{N4} and E_{N3} respectively. Moreover, the requirement DC=½ results in T_{Z3}=T_{DZ1}+T_{DZ2}, such that, during each single-direction pass through the ELIT 10, the time spent by the at least one ion 30 passing through the charge detection cylinder CD should be approximately equal to the sum of the time spent reflecting the at least one ion 30 from a stopped state in one of the ion mirrors M1, M2 to the respective end or entrance of the charge detection cylinder CD and the time spent by the ion exiting the opposite end of the charge detection cylinder CD and traveling toward and into the other ion mirror M1, M2 to a stopped state.

In order to achieve a 50% duty cycle with the ELIT 10′, the time spent by at least one ion 30 traversing the distance DZ1′+Z3′+DZ2′ must be equal to the time spent by the at least one ion 30 traversing the distance DZ2′+Z3′+DZ1′ in the opposite direction. The duty cycle equation set forth in the previous paragraph thus simplifies to DC=T_{Z3}′/(T_{DZ1}′+T_{Z3}′+T_{DZ2}′), where T_{Z3}′ is the time spent by the at least one ion 30 traversing D3′ in either direction, T_{DZ1}′ is the time spent by the at least one ion 30 travelling through each of DZ1′ and DZ2′ toward the other and T_{DZ2}′ is the time spent by the at least one ion 30 traveling into each of DZ1′ and DZ2′ prior to being reflected, i.e., prior to changing directions under the influence of the net electric fields E_{N4} and E_{N3} respectively. Moreover, the requirement DC=½ results in T_{Z3}′=T_{DZ1}′+T_{DZ2}′, such that, during each single-direction pass through the ELIT 10′, the time spent by the at least one ion 30 passing through the charge detection cylinder CD' should be approximately equal to the sum of the time spent reflecting the at least one ion 30 from a stopped state in one of the ion mirrors M1, M2 to the respective end or entrance of the charge detection cylinder CD′ and the time spent by the ion exiting the opposite end of the charge detection cylinder CD′ and traveling toward and into the other ion mirror M1, M2 to a stopped state.

Referring again to FIGS. 2, 4, and 5, the processor 12 is illustratively operable at steps 102, 106, 110 and 116 to control the output voltages VO1-VO6 produced by the voltage sources V1-V6 in a manner which establishes the net electric fields E_{N1}-E_{N4} described above, taking into account the dimensions of the ELIT 10, 10′, particularly, but not exclusively, the axial lengths DZ1, DZ2, Z3, DZ1′, DZ2′, and Z3′ and the cross-sectional areas, e.g., radial diameters, P1 and P3, that results in approximately a 50% duty cycle of the oscillating charge detection signal. Using the example dimensions of the ELIT 10 illustrated in TABLE I above, one example set of output voltages VO1-VO6 produced by the voltage sources V1-V6 respectively at each of the four steps 102, 106, 110 and 116 is shown in TABLE III below. Using the example dimensions of the ELIT 10′ illustrated in TABLE II above, one example set of output voltages VO1-VO6 produced by the voltage sources V1-V6 respectively at each of the four steps 102, 106, 110 and 116 is shown in TABLE IV below. It will be understood that the following values of VO1-VO6 are provided only by way of example, and that other values of VO1, VO2, VO3, VO4, VO5 and/or VO6 at one or more of the steps 102, 106, 110, 116 may alternatively be used.

TABLE III

| Step of | Output Voltages |
|---|---|
| Process 100 | (volts DC) |
| 102 | VO1 = VO6 = 0 |
| | VO2 = VO5 = 60 |
| | VO3 = VO4 = 141.8 |
| 106 | VO1 = 0 |
| | VO2 = 60 |
| | VO3 = 141.8 |
| | VO4 = 141.8 |
| | VO5 = 141.8 |
| | VO6 = 222 |
| 110 | VO1 = VO6 = 222 |
| | VO2 = VO5 = 141.8 |
| | VO3 = VO4 = 141.8 |
| 116 | VO1 = VO6 = 0 |
| | VO2 = VO5 = 60 |
| | VO3 = VO4 = 141.8 |

TABLE IV

| Step of | Output Voltages |
|---|---|
| Process 100 | (volts DC) |
| 102 | VO1 = VO6 = 0 |
| | VO2 = VO5 = 60 |
| | VO3 = VO4 = 141.8 |
| 106 | VO1 = 0 |
| | VO2 = 60 |
| | VO3 = 141.8 |
| | VO4 = 141.8 |
| | VO5 = 141.8 |
| | VO6 = 222 |
| 110 | VO1 = VO6 = 222 |
| | VO2 = VO5 = 141.8 |
| | VO3 = VO4 = 141.8 |
| 116 | VO1 = VO6 = 0 |
| | VO2 = VO5 = 60 |
| | VO3 = VO4 = 141.8 |

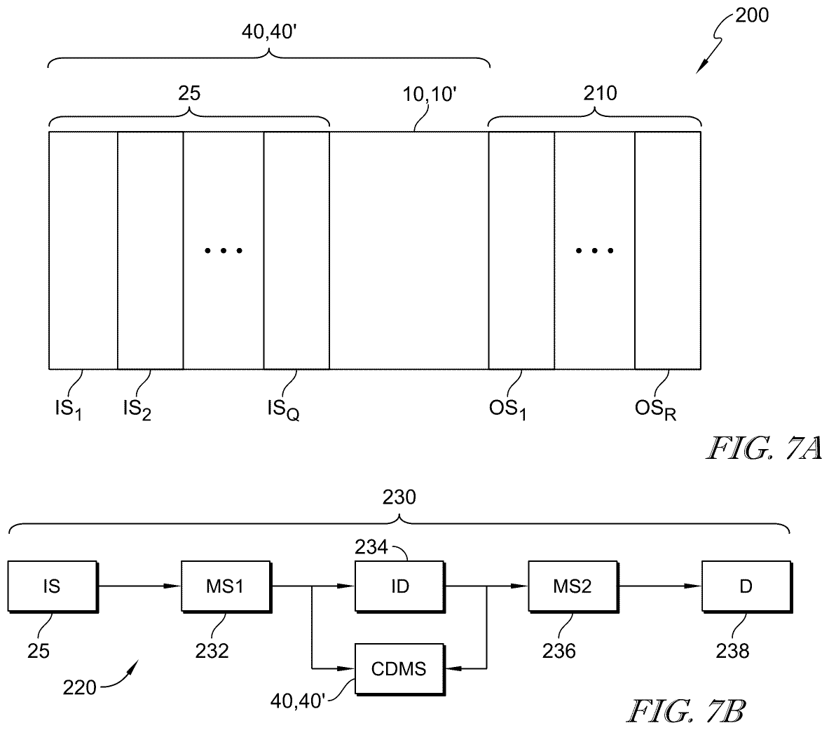

Referring now to FIG. 7A, a simplified block diagram is shown of an embodiment of an ion, i.e., charged particle, separation instrument 200 which may include the ELIT 10 or the ELIT 10′ configured and operable as described herein, which may include the CDMS 40 or the CDMS 40′ configured and operable as described herein, which may include any number of ion processing instruments forming part of the ion source 25 upstream of the ELIT 10, 10′ and/or which may include any number of ion processing instruments disposed downstream of the ELIT 10, 10′ to further process ions exiting the ELIT 10, 10′. In this regard, the ion source 25 is illustrated in FIG. 7A as including a number, Q, of ion source stages IS₁-IS_{Q} which may be or form part of the ion source 25 described in one form above with respect to FIG. 2, where Q may be any positive integer. Alternatively or additionally, an ion processing instrument 210 is illustrated in FIG. 7A as being coupled to the ion outlet of the ELIT 10, 10′, wherein the ion processing instrument 210 may include any number of ion processing stages OS₁-OS_{R}, where R may be any positive integer.

Focusing on the ion source 25, it will be understood that the source 25 of ions entering the ELIT 10, 10′ may be or include, in the form of one or more of the ion source stages IS₁-IS_{Q}, one or more conventional sources of ions as described above, and may further include one or more conventional instruments for separating ions according to one or more molecular characteristics (e.g., according to ion mass, ion mass-to-charge, ion mobility, ion retention time, or the like) and/or one or more conventional ion processing instruments for collecting and/or storing ions (e.g., one or more quadrupole, hexapole and/or other ion traps), for filtering ions (e.g., according to one or more molecular characteristics such as ion mass, ion mass-to-charge, ion mobility, ion retention time, and the like), for fragmenting or otherwise dissociating ions, for normalizing or shifting ion charge states, and the like. It will be understood that the ion source 25 may include one or any combination, in any order, of any such conventional ion sources, ion separation instruments, and/or ion processing instruments, and that some embodiments may include multiple adjacent or spaced-apart ones of any such conventional ion sources, ion separation instruments, and/or ion processing instruments. In any implementation which includes one or more mass spectrometers, any one or more such mass spectrometers may be implemented in any of the forms described above with respect to FIG. 2.

Turning now to the ion processing instrument 210, it will be understood that the instrument 210 may be or include, in the form of one or more of the ion processing stages OS₁-OS_{R}, one or more conventional instruments for separating ions according to one or more molecular characteristics (e.g., according to ion mass, ion mass-to-charge, ion mobility, ion retention time, or the like) and/or one or more conventional ion processing instruments for collecting and/or storing ions (e.g., one or more quadrupole, hexapole, and/or other ion traps or guides), for filtering ions (e.g., according to one or more molecular characteristics such as ion mass, ion mass-to-charge, ion mobility, ion retention time, and the like), for fragmenting or otherwise dissociating ions, for normalizing or shifting ion charge states, and the like. It will be understood that the ion processing instrument 210 may include one or any combination, in any order, of any such conventional ion separation instruments and/or ion processing instruments, and that some embodiments may include multiple adjacent or spaced-apart ones of any such conventional ion separation instruments and/or ion processing instruments. In any implementation which includes one or more mass spectrometers, any one or more such mass spectrometers may be implemented in any of the forms described above with respect to FIG. 2.

As one specific implementation of the ion separation instrument 200 illustrated in FIG. 7A, which should not be considered to be limiting in any way, the ion source 25 illustratively includes 3 stages, and the ion processing instrument 210 is omitted. In this example implementation, the ion source stage IS₁ is a conventional source of ions, e.g., electrospray, MALDI or the like, the ion source stage IS₂ is a conventional ion filter, e.g., a quadrupole or hexapole ion guide, and the ion source stage IS₃ is a mass spectrometer of any of the types described above. In this embodiment, the ion source stage IS₂ is controlled in a conventional manner to preselect ions having desired molecular characteristics for analysis by the downstream mass spectrometer, and to pass only such preselected ions to the mass spectrometer, wherein the ions analyzed by the ELIT 10, 10′ will be the preselected ions separated by the mass spectrometer according to mass or mass-to-charge ratio. The preselected ions exiting the ion filter may, for example, be ions having a specified ion mass or mass-to-charge ratio, ions having ion masses or ion mass-to-charge ratios above and/or below a specified ion mass or ion mass-to-charge ratio, ions having ion masses or ion mass-to-charge ratios within a specified range of ion mass or ion mass-to-charge ratio, or the like. In some alternate implementations of this example, the ion source stage IS₂ may be the mass spectrometer and the ion source stage IS₃ may be the ion filter, and the ion filter may be otherwise operable as just described to preselect ions exiting the mass spectrometer which have desired molecular characteristics for analysis by the downstream ELIT 10, 10′. In other alternate implementations of this example, the ion source stage IS₂ may be the ion filter, and the ion source stage IS₃ may include a mass spectrometer followed by another ion filter, wherein the ion filters each operate as just described.

As another specific implementation of the ion separation instrument 200 illustrated in FIG. 7A, which should not be considered to be limiting in any way, the ion source 25 illustratively includes 2 stages, and the ion processing instrument 210 is again omitted. In this example implementation, the ion source stage IS₁ is a conventional source of ions, e.g., electrospray, MALDI or the like, the ion source stage IS₂ is a conventional mass spectrometer of any of the types described above. This is the CDMS implementation described above with respect to FIG. 2 in which the ELIT 10 is operable to analyze ions exiting the mass spectrometer.

As yet another specific implementation of the ion separation instrument 200 illustrated in FIG. 7A, which should not be considered to be limiting in any way, the ion source 25 illustratively includes 2 stages, and the ion processing instrument 210 is omitted. In this example implementation, the ion source stage IS₁ is a conventional source of ions, e.g., electrospray, MALDI or the like, and the ion processing stage OS₂ is a conventional single or multiple-stage ion mobility spectrometer. In this implementation, the ion mobility spectrometer is operable to separate ions, generated by the ion source stage IS₁, over time according to one or more functions of ion mobility, and the ELIT 10, 10′ is operable to analyze ions exiting the ion mobility spectrometer. In an alternate implementation of this example, the ion source 25 may include only a single stage IS₁ in the form of a conventional source of ions, and the ion processing instrument 210 may include a conventional single or multiple-stage ion mobility spectrometer as a sole stage OS₁ (or as stage OS1 of a multiple-stage instrument 210). In this alternate implementation, the ELIT 10, 10′ is operable to analyze ions generated by the ion source stage IS₁, and the ion mobility spectrometer OS₁ is operable to separate ions exiting the ELIT 10, 10′ over time according to one or more functions of ion mobility. As another alternate implementation of this example, single or multiple-stage ion mobility spectrometers may follow both the ion source stage IS₁ and the ELIT 10, 10′. In this alternate implementation, the ion mobility spectrometer following the ion source stage IS₁ is operable to separate ions, generated by the ion source stage IS1, over time according to one or more functions of ion mobility, the ELIT 10, 10′ is operable to analyze ions exiting the ion source stage ion mobility spectrometer, and the ion mobility spectrometer of the ion processing stage OS₁ following the ELIT 10, 10′ is operable to separate ions exiting the ELIT 10, 10′ over time according to one or more functions of ion mobility. In any implementations of the embodiment described in this paragraph, additional variants may include a mass spectrometer operatively positioned upstream and/or downstream of the single or multiple-stage ion mobility spectrometer in the ion source 25 and/or in the ion processing instrument 210.

As still another specific implementation of the ion separation instrument 200 illustrated in FIG. 7A, which should not be considered to be limiting in any way, the ion source 25 illustratively includes 2 stages, and the ion processing instrument 210 is omitted. In this example implementation, the ion source stage IS₁ is a conventional liquid chromatograph, e.g., HPLC or the like configured to separate molecules in solution according to molecule retention time, and the ion source stage IS₂ is a conventional source of ions, e.g., electrospray or the like. In this implementation, the liquid chromatograph is operable to separate molecular components in solution, the ion source stage IS₂ is operable to generate ions from the solution flow exiting the liquid chromatograph, and the ELIT 10, 10′ is operable to analyze ions generated by the ion source stage IS₂. In an alternate implementation of this example, the ion source stage IS₁ may instead be a conventional size-exclusion chromatograph (SEC) operable to separate molecules in solution by size. In another alternate implementation, the ion source stage IS₁ may include a conventional liquid chromatograph followed by a conventional SEC or vice versa. In this implementation, ions are generated by the ion source stage IS₂ from a twice separated solution; once according to molecule retention time followed by a second according to molecule size, or vice versa. In any implementations of the embodiment described in this paragraph, additional variants may include a mass spectrometer operatively positioned between the ion source stage IS₂ and the ELIT 10, 10′.

Referring now to FIG. 7B, a simplified block diagram is shown of another embodiment of an ion separation instrument 220 which illustratively includes a multi-stage mass spectrometer instrument 230 and which also includes the charge detection mass spectrometer (CDMS) 40 or the CDMS 40′, illustrated in FIGS. 2 and 4 and described herein and implemented in the embodiment of FIG. 7B as a high-mass ion analysis component. In the illustrated embodiment, the multi-stage mass spectrometer instrument 230 includes an ion source (IS) 25, as illustrated and described herein, followed by and coupled to a first conventional mass spectrometer (MS1) 232, followed by and coupled to a conventional ion dissociation stage (ID) 234 operable to dissociate ions exiting the mass spectrometer 232, e.g., by one or more of collision-induced dissociation (CID), surface-induced dissociation (SID), electron capture dissociation (ECD), and/or photo-induced dissociation (PID) or the like, followed by an coupled to a second conventional mass spectrometer (MS2) 236, followed by a conventional ion detector (D) 238, e.g., such as a microchannel plate detector or other conventional ion detector. The CDMS 40, 40′ is coupled in parallel with and to the ion dissociation stage 234 such that the CDMS 40, 40′ may selectively receive ions from the mass spectrometer 236 and/or from the ion dissociation stage 232.

MS/MS, e.g., using only the ion separation instrument 230, is a well-established approach where precursor ions of a particular molecular weight are selected by the first mass spectrometer 232 (MS1) based on their m/z value. The mass selected precursor ions are fragmented, e.g., by collision-induced dissociation, surface-induced dissociation, electron capture dissociation or photo-induced dissociation, in the ion dissociation stage 234. The fragment ions are then analyzed by the second mass spectrometer 236 (MS2). Only the m/z values of the precursor and fragment ions are measured in both MS1 and MS2. For high mass ions, the charge states are not resolved and so it is not possible to select precursor ions with a specific molecular weight based on the m/z value alone. However, by coupling the instrument 230 to the CDMS 40, 40′ illustrated and described herein, it is possible to select a narrow range of m/z values using MS1 and then use the CDMS 40, 40′ to determine the masses of the m/z selected precursor ions. The mass spectrometers 232, 236 may be, for example, one or any combination of a magnetic sector mass spectrometer, time-of-flight mass spectrometer or quadrupole mass spectrometer, although in alternate embodiments other mass spectrometer types may be used, non-limiting examples of which are described hereinabove. In any case, the m/z selected precursor ions with known masses exiting MS1 can be fragmented in the ion dissociation stage 234, and the resulting fragment ions can then be analyzed by MS2 (where only the m/z ratio is measured) and/or by the CDMS instrument 40, 40′ (where the m/z ratio and charge are measured simultaneously). Low mass fragments, i.e., dissociated ions of precursor ions having mass values below a threshold mass value, e.g., 10,000 Da (or other mass value), can thus be analyzed by conventional MS, using MS2, while high mass fragments (where the charge states are not resolved), i.e., dissociated ions of precursor ions having mass values at or above the threshold mass value, can be analyzed by CDMS.

It will be understood that one or more charge detection optimization techniques may be used with the ELIT 10, 10′ alone and/or in any of the systems 40, 40′, 200, 220 illustrated in the attached figures and described herein, e.g., for trigger trapping and/or other charge detection events. Examples of some such charge detection optimization techniques are illustrated and described in International Publication No. WO 2019/236141 A1, the disclosure of which is expressly incorporated herein by reference in its entirety.

It will be further understood that one or more charge calibration or resetting apparatuses may be used with the charge detection cylinder CD, CD′ of the ELIT 10, 10′ alone and/or in any of the systems 40, 40′, 200, 220 illustrated in the attached figures and described herein. An example of one such charge calibration or resetting apparatus is illustrated and described in International Publication No. WO 2019/236143 A1, the disclosure of which is expressly incorporated herein by reference in its entirety.

It will be still further understood that the design concepts for achieving a desired duty cycle within the ELIT 10, 10′ alone and/or in any of the systems 40, 40′, 200, 220 illustrated in the attached figures and described herein may be implemented in an ELIT array including two or more ELITs and/or in any ELIT including two or more ELIT regions. Examples of some such ELITs and/or ELIT arrays are illustrated and described in International Publication No. WO 2019/236142 A1, the disclosure of which is expressly incorporated herein by reference in its entirety.

It will be further understood that one or more ion source optimization apparatuses and/or techniques may be used with one or more embodiments of the ion source 25 illustrated and described herein in combination with the ELIT 10, 10′ along and/or in any of the systems 40, 40′, 200, 220 illustrated in the attached figures and described herein, some examples of which are illustrated and described in International Publication No. WO 2019/236139 A1, the disclosure of which is expressly incorporated herein by reference in its entirety.

It will be still further understood that the charge detection mass spectrometer 40, 40′, the ion separation instrument 200, the ion separation instrument 230 and/or the ELIT 10, 10′ illustrated in the attached figures and described herein may be implemented in accordance with real-time analysis and/or real-time control techniques, some examples of which are illustrated and described in International Publication No. WO 2019/236140 A1, the disclosure of which is expressly incorporated herein by reference in its entirety.

It will be yet further understood that one or more ion inlet trajectory control apparatuses and/or techniques may be used with the ELIT 10, 10′ alone and/or in any of the systems 40, 40′, 200, 220 illustrated in the attached figures and described herein to provide for simultaneous measurements of multiple individual ions within the ELIT 10, 10′. Examples of some such ion inlet trajectory control apparatuses and/or techniques are illustrated and described in International Publication No. WO 2020/117292 A1 the disclosure of which is expressly incorporated herein by reference in its entirety.

While this disclosure has been illustrated and described in detail in the foregoing drawings and description, the same is to be considered as illustrative and not restrictive in character, it being understood that only illustrative embodiments thereof have been shown and described and that all changes and modifications that come within the spirit of this disclosure are desired to be protected. For example, while the ELIT 10, 10′ illustrated in the attached figures has been described herein as being designed and operated with an oscillating charge detection signal having a duty cycle of approximately 50% for the purpose of reducing noise in fundamental frequency magnitude determinations resulting from harmonic frequency components of the signal, this disclosure also contemplates alternatively or additionally employing other structures and/or techniques for reducing the effects of harmonic frequency components on such fundamental frequency magnitude determinations. Examples of such other structures and/or techniques may include, but are not limited to, one or more harmonic component filtering structures and/or techniques, one or more wave-shaping structures and/or techniques, one or more multi-phase operating structures and/or techniques, and the like. As another example, although the ion mirrors M1 and M2 are illustrated in the attached figures and described herein as each including an aligned arrangement of three spaced-apart mirror electrodes, it will be understood that such embodiments are provided only by way of example and should not be considered limiting in any way. Alternate embodiments in which either or both of the ion mirrors M1, M2 include more or fewer mirror electrodes are intended to fall within the scope of this disclosure. As yet another example, it will be understood that the steps of the process 100 illustrated in the attached figures and described herein are also provided only by way of example and should not be considered limiting in any way. Alternate techniques for operating the ELIT 10, 10′ described herein to capture the measurements and data described herein are intended to fall within the scope of this disclosure, and it will be recognized that any such alternate techniques will be a mechanical step for one skilled in the art using the concepts described herein as a template. As still another example, it will be understood that the ELIT 10, 10′ illustrated in the attached figures and described herein is provided only by way of example, and that the concepts, structures and techniques described above may be implemented directly in ELITs of various alternate designs. Any such alternate ELIT design may, for example, include any one or combination of two or more ELIT regions, more, fewer and/or differently-shaped ion mirror electrodes, more or fewer voltage sources, more or fewer DC or time-varying signals produced by one or more of the voltage sources, one or more ion mirrors defining additional electric field regions, or the like.

What is claimed is:

1. An electrostatic linear ion trap, comprising:
a first ion mirror defining a first axial passageway therethrough,
a first ground electrode defining a second axial passageway therethrough and positioned adjacent the first ion mirror,
a second ion mirror defining a third axial passageway therethrough,
a second ground electrode defining a fourth axial passageway therethrough and positioned adjacent the second ion mirror,
a charge detection cylinder defining a fifth axial passageway therethrough and positioned between the first and second ground electrodes,
a first nozzle defining a sixth axial passageway therethrough and extending outwardly from the first ground electrode toward the charge detection cylinder to position the first nozzle adjacent the charge detection cylinder,
a second nozzle defining a seventh axial passageway therethrough and extending outwardly from the second ground electrode toward the charge detection cylinder to position the second nozzle adjacent the charge detection cylinder, and
at least one voltage source coupled to the first and second ion mirrors, the at least one voltage source configured to establish electric fields in each of the first and second ion mirrors configured to reflect an ion entering a respective one of the first and third axial passageways from the fifth axial passageway of the charge detection cylinder back through the fifth axial passageway of the charge detection cylinder and toward the other of the first and third axial passageways such that the ion oscillates back and forth through the charge detection cylinder between the first and second ion mirrors,
wherein the first nozzle and the second nozzle are configured to reduce noise in a charge detection signal related to charges induced on the charge detection cylinder due to oscillation of the ion back and forth through the charge detection cylinder between the first and second ion mirrors.

2. The electrostatic linear ion trap of claim 1, wherein the first, second, third, fourth, fifth, sixth, and seventh axial passageways are in-line with each other relative to an axis.

3. The electrostatic linear ion trap of claim 1, wherein each of the first and second ion mirrors comprise a plurality of axially spaced apart mirror electrodes defining the first and third axial passageways respectively therethrough,
and wherein the at least one voltage source comprises a plurality of voltage sources each electrically connected to a different one of the plurality of spaced apart mirror electrodes of the first and second ion mirrors, each of the plurality of voltage sources configured to apply a potential to a corresponding one of the plurality of mirror electrodes to establish the electric fields between at least some of the spaced apart mirror electrodes of each of the first and second ion mirrors.

4. The electrostatic linear ion trap of claim 1, further comprising a processor and a memory having instructions stored therein which, when executed by the processor, cause the processor to control the at least one voltage source to produce at least one output voltage to establish the electric fields in the first and third axial passageways of the first and second ion mirrors, respectively.

5. The electrostatic linear ion trap of claim 1, wherein a first axial length is defined between a proximal end of the first axial passageway defined by the first ion mirror and one end of the charge detection cylinder adjacent to a distal end of the first nozzle, a second axial length is defined between a proximal end of the third axial passageway defined by the second ion mirror and an opposite end of the charge detection cylinder adjacent to a distal end of the second nozzle, and a third axial length is defined along the fifth axial passageway between the one end of the charge detection cylinder and the opposite end of the charge detection cylinder,
and wherein the at least one voltage source is configured to establish the electric fields in each of the first and second ion mirrors by applying at least one output voltage to each of the first and second ion mirrors, the at least one output voltage having at least one magnitude based, at least in part, on the first, second, and third axial lengths.

6. The electrostatic linear ion trap of claim 5, wherein the first axial length is approximately equal to the second axial length,
and wherein the third axial length is greater than each of the first and second axial lengths.

7. The electrostatic linear ion trap of claim 5, wherein the first axial passageway of the first ion mirror defines a first cross-sectional area normal to the first axial length, the third axial passageway of the second ion mirror defines a second cross-sectional area normal to the second axial length, and the fifth axial passageway defines a third cross-sectional area normal to the third axial length,
and wherein the at least one magnitude is further based, at least in part, on the first, second, and third cross-sectional areas.

8. The electrostatic linear ion trap of claim 7, wherein the first cross-sectional area is approximately equal to the second cross-sectional area,
and wherein the third cross-sectional area is less than each of the first and second cross-sectional areas.

9. The electrostatic linear ion trap of claim 8, wherein the sixth axial passageway of the first nozzle defines a fourth cross-sectional area normal to the first axial length and the seventh axial passageway defines a fifth cross-sectional area normal to the second axial length, wherein the fourth cross-sectional area is approximately equal to the fifth cross-sectional area,
and wherein the fourth and fifth cross-sectional areas are each less than the third cross-sectional area.

10. The electrostatic linear ion trap of claim 1, further comprising:
a processor operatively coupled to the charge detection cylinder, the charge detection cylinder producing the charge detection signal for each corresponding detection of the ion passing through the fifth axial passageway, and
a memory having instructions stored therein which, when executed by the processor, cause the processor to store the charge detection signals produced by the charge detection cylinder in the memory.

11. The electrostatic linear ion trap of claim 10, wherein the memory further includes instructions stored therein which, when executed by the processor, cause the processor to compute a Fourier transform of a plurality of the stored charge detection signals resulting from oscillation of the ion multiple times back and forth through the fifth axial passageway of the charge detection cylinder between the first and second ion mirrors, to compute a mass-to-charge ratio of the ion as a function of a fundamental frequency of the Fourier transform, to compute a charge of the ion as a function of a magnitude of the fundamental frequency of the Fourier transform taking into account the number oscillations of the ion, and to compute a mass of the ion based on the computed mass-to-charge ratio and the computed charge.

12. The electrostatic linear ion trap of claim 10, further comprising a charge pre-amplifier operatively coupled between the charge detection cylinder and the processor, the charge pre-amplifier amplifying the charge detection signals, the processor digitizing the amplified charge detection signals and storing the digitized, amplified charge detection signals in the memory.

13. The electrostatic linear ion trap of claim 1, wherein a distance is formed between the first ground electrode and the charge detection cylinder, the first nozzle has a length that is less than the distance between the first ground electrode and the charge detection cylinder to form a gap between the first nozzle and the charge detection cylinder, and
wherein the distance is formed between the second ground electrode and the charge detection cylinder, the second nozzle has the length that is less than the distance between the second ground electrode and the charge detection cylinder to form the gap between the second nozzle and the charge detection cylinder.

14. A system for separating ions comprising:
an ion source configured to generate ions from a sample,
at least one ion separation instrument configured to separate the generated ions as a function of at least one molecular characteristic, and
the electrostatic linear ion trap of claim 1, wherein one of the first and second ion mirrors defines an aperture configured to allow passage of at least one ion exiting the at least one ion separation instrument into the one of the first and second ion mirrors for oscillation thereof back and forth through the charge detection cylinder between the first and second ion mirrors.

15. A method of operating an electrostatic linear ion trap having first and second ion mirrors separated by a charge detection cylinder and first and second nozzles separated by the charge detection cylinder, each of the first and second ion mirrors, the charge detection cylinder, and the first and second nozzles axially aligned with one another, the method comprising:
establishing a first electric field in the first ion mirror, the first electric field configured and oriented to stop in the first ion mirror an ion exiting a first end of the charge detection cylinder proximate to the first nozzle and traveling into the first ion mirror, and to accelerate the stopped ion in the first ion mirror back through the first nozzle and into the first end of the charge detection cylinder, and
establishing a second electric field in the second ion mirror, the second electric field configured and oriented to stop in the second ion mirror the ion exiting a second end of the charge detection cylinder, opposite the first end thereof, proximate to the second nozzle and traveling into the second ion mirror, and to accelerate the stopped ion in the second ion mirror back through the second nozzle and the second end of the charge detection cylinder, such that the ion oscillates through the charge detection cylinder back and forth between the first and second ion mirrors under the influence of the first and second electric fields.

16. The method of claim 15, wherein the charge detection cylinder produces a charge detection signal each time the ion passes therethrough, and wherein the method further comprises storing the charge detection signals produced by the charge detection cylinder in a memory, and wherein the method further comprises reducing noise in the charge detection signals via the first and second nozzles.

17. The method of claim 15, wherein a first axial length is defined between a proximal end of the first ion mirror and one end of the charge detection cylinder adjacent to the first nozzle, a second axial length is defined between a proximal end of the second ion mirror and an opposite end of the charge detection cylinder adjacent to the second nozzle, and a third axial length is defined between the one end of the charge detection cylinder and the opposite end of the charge detection cylinder,
and wherein establishing the first electric field comprises applying at least a first voltage to the first ion mirror, the at least the first voltage having at least one magnitude based, at least in part, on the first, second, and third axial lengths,
and wherein establishing the second electric field comprises applying at least a second voltage to the second ion mirror, the at least the second voltage having at least one magnitude based, at least in part, on the first, second and third axial lengths.

18. The method of claim 17, wherein the first ion mirror defines a first axial passageway defining a portion of the first axial length, the first axial passageway having a first cross-sectional area normal to the first axial length,
and wherein the second ion mirror defines a second axial passageway defining a portion of the second axial length, the second axial passageway having a second cross-sectional area normal to the second axial length,
and wherein the charge detection cylinder defines a third axial passageway therethrough defining the third axial length, the third axial passageway having a third cross-sectional area normal to the third axial length,
and wherein the at least one magnitude of each of the first voltage and the second voltage is further based, at least in part, on the first, second, and third cross-sectional areas.

19. The method of claim 18, wherein the first nozzle defines a fourth axial passageway defining another portion of the first axial length, the fourth axial passageway having a fourth cross-sectional area normal to the first axial length,
and wherein the second nozzle defines a fifth axial passageway defining another portion of the second axial length, the fifth axial passageway having a fifth cross-sectional area normal to the second axial length.

20. The method of claim 19, further comprising sizing the fourth cross-sectional area to be approximately equal to the fifth cross-sectional area,
sizing the fourth cross-sectional area and the fifth cross-sectional area to be less than each of the first, second, and third cross-sectional areas, sizing the first cross-sectional area to be approximately equal to the second cross-sectional area, and
sizing the third cross-sectional area to be less than each of the first and second cross-sectional areas.
